(19) United States
(12) Patent Application Publication
(10) Pub. No.: US 2020/0056613 A1
(43) Pub. Date: Feb. 20, 2020

(54) External Lobe Rotary Compressor, Expander, or Engine

(71) Applicant: Roy Michael Kies, Greenfield, WI (US)

(72) Inventor: Roy Michael Kies, Greenfield, WI (US)

(73) Assignee: Roy Michael Kies, Greenfield, WI (US)

(21) Appl. No.: 16/105,394

(22) Filed: Aug. 20, 2018

(51) Int. Cl. F04C 29/04; F02C 3/36; F04C 18/12; F01C 1/12; F01C 21/06

(52) U.S. Cl. CPC F04C 29/04; F02C 3/36; F02C 7/36; F01C 1/126; F01C 21/06; F04C 18/126

(57) ABSTRACT

In a conventional screw compressor, two mating rotors which resemble screws are assembled in parallel with each other within a housing. These rotors are very costly to manufacture, and it is very difficult to extract all of the gas that has been compressed between the lobes of the rotor screws. This invention eliminates the twist of the lobes around the rotor of a conventional screw compressor. In this invention, the lobes are manufactured in line with the axis of the rotor (axially). As a result, the costs of manufacturing the rotors are reduced dramatically, and the natural tendency for the gas to be driven towards the center of the female rotor is taken advantage of, making it much easier to extract practically all of the gas that has been compressed between the lobes.

### BRIEF DESCRIPTION OF THE DRAWINGS

FIG. 1 through FIG. 3: FIG. 1 through FIG. 3 simulate existing technology by repeatedly copying a dot at specified intervals along the specified route to determine the curve created on the active sides of both rotors.

FIG. 4 through FIG. 9: Using an elliptical arc with defined limits to determine the curve created by the reactive lower sidewall k, FIG. 6, were created to trace the outline of the reactive part of the right lobe.

FIG. 10 through FIG. 16: FIG. 10 through FIG. 16 show the most important sequential intervals demonstrating the interaction between the two rotors. The male rotor on the left rotates at twice the speed of the female rotor on the right. The female rotor's lobes are permanently attached to the flanges, and rotate freely around the stationary shaft 5, FIG. 10.

FIG. 17 through FIG. 19: FIG. 18 and FIG. 19 demonstrate how the gas in cavity 8, is discharged into Channel 7 FIG. 17, FIG. 18, and FIG. 19.

FIG. 20: FIG. 20 is a magnification of FIG. 19 to show a greater detail the proper placement of the slot 9 of FIG. 19.

FIG. 21 through FIG. 23: FIGS. 21 through 23 show how, with the addition of another identical two lobe rotor on the right side, this compressor or expander can have its capacity doubled.

FIG. 24 and FIG. 25: FIG. 24 and FIG. 25 show how such a triple rotor compressor or expander can be cooled by blowing cooling air through the channels 27 and 28, created within each of those three rotors. The stationary shaft is also cooled by blowing cooling air through the channels 29 FIG. 25.

FIG. 26A and FIG. 26B: FIG. 26A and FIG. 26B have slotted cylinders, 18 and 24 for air cooling and these slotted cylinders also fit over the outside diameter of the bearings 22 and 23, to provide support for the flanged rotor 1, FIG. 26A and FIG. 26B.

FIGS. 27A through 27D: FIG. 27A shows a cross-sectional main cut through the center of a triple rotor machine, FIG. 27B shows a cross-sectional top view of FIG. 27A. FIG. 27C shows a right side view of FIG. 27A, cut through the center of the right two lobe rotor. FIG. 27D shows a right side view cut made through the center of the upper half of 27A. These 4 figures are shown together on one sheet to create a better understanding of the drawings.

FIG. 28A and FIG. 28B: FIGS. 28A and 28B are the same as FIGS. 27A and 27B, but placed together on one sheet in order to more clearly identify the various parts yet still show the relationships between the two views. This allows better explanation of the various parts of this machine.

FIG. 29: FIG. 29 is the same as FIG. 28B and FIG. 27B without the clutter of lead lines and numbers in order to better comprehend the various parts of this machine.

FIG. 30: FIG. 30 is the same as FIG. 27D, but enlarged so the various parts can be displayed and identified. A clearly shows cooling air channels with their supply and discharge cooling air Plenums, and if stationary shaft bearing.

FIGS. 31A through 31D: FIGS. 31A through 31D showed a stationary for lobe shaft in its entirety along with 3 sectional cuts to better comprehend the air cooling channels.

FIG. 32A through FIG. 32D: FIG. 32A through FIG. 32D are the same as FIGS. 31A through 31D except for the addition of a high-pressure pipe supporting structure 37, FIG. 32A which is anchored to the cover plate 43 FIGS. 35, 38 and 39.

FIG. 33A through FIG. 33C: FIG. 33a through FIG. 33C shows the 4 lobe rotor assembly, complete with left end and right end sectional views. The large gear the left end of FIG. 33B of the assembly engage the two half sized gears to provide timing for the machine.

FIG. 34A through FIG. 34C: FIG. 34A through FIG. 34C show the relationship between the two lobe rotors and the four lobe rotor. FIG. 34A through FIG. 34C show the three rotors with their housing removed.

FIG. 35: FIG. 35 is an enlarged version of FIG. 27C. FIG. 35 shows a cross-sectional view of section B-B of FIG. 24 and FIG. 38B. FIG. 35 shows the vacuum relief slots 17 which are caused in the cavity 69, FIG. 18.

FIG. 36 and FIG. 37: FIG. 36 and FIG. 37 are similar. FIG. 36 shows one of the two lobe rotors complete with all of its parts, while FIG. 37 shows a larger view with the fan 24, the cover plate 43, and the plenum housing 50 removed.

FIG. 38A and FIG. 38B: FIG. 38A is the cover plate 43, which shows the air intake ports 25 and a high-pressure gas pipe 14; and FIG. 38B is a repeat of FIG. 25 to show the relationship between the two drawings.

FIG. 39A and FIG. 39B: FIG. 39A shows the outside view of the cover plate 43, with a high-pressure gas pipe support structure 37. FIG. 39B shows an outside view of the gear case with its protruding who lobe shafts.

FIG. 40A and FIG. 40B; and FIGS. 41A and 41B are included to show more clearly how the blower end sidewall, which contains three large cooling air feed holes (openings) are shown as the three larger circles within FIG. 41A.

FIG. 42 shows an outside left side view of the assembled compressor or expander with the gear end on the right.

FIG. 43 shows the diagram for an engine which is composed of four main parts, the motor 57, the compressor 52, the combustion chamber 58 and expander 51.

FIG. 44 shows a diagram for an engine which is composed of five main parts, the motor 57, a compressor 52, the combustion chamber 58, the expander 51, and an overriding clutch.

FIG. 45 shows a drawing of a four rotor machine.

FIG. 46 shows a drawing of a five rotor machine.

### DETAILED DESCRIPTION OF THE INVENTION

This invention includes the use of two or more rotors which contain two or more lobes. This invention is a novel use of an axial compressor which uses two rotors connected together by a 2 to 1 gear train. This invention borrows one feature from a conventional screw compressor, wherein the mating profile of one compressor screw which contains male lobes mates with another screw which contains female lobes.

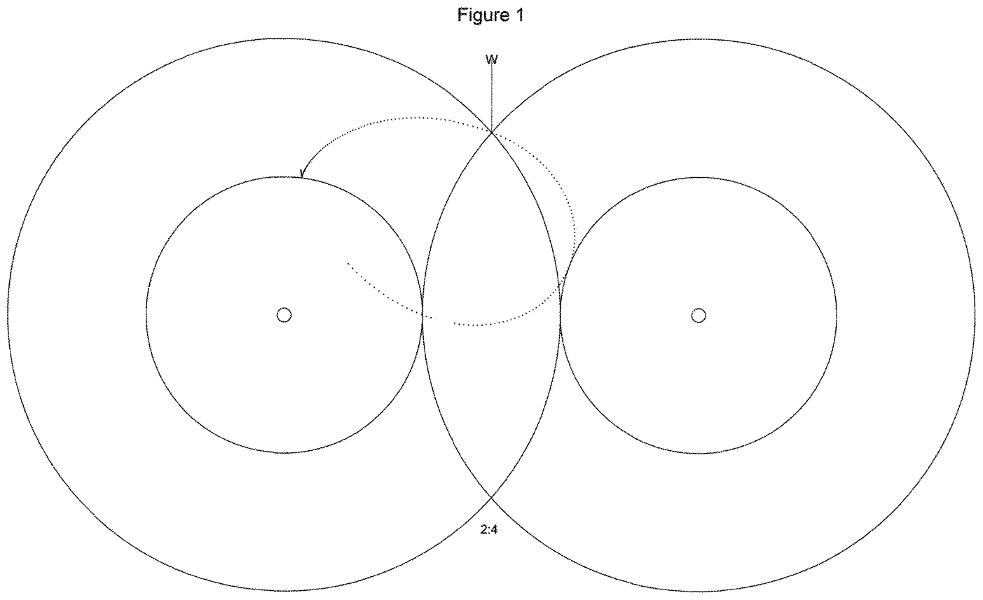

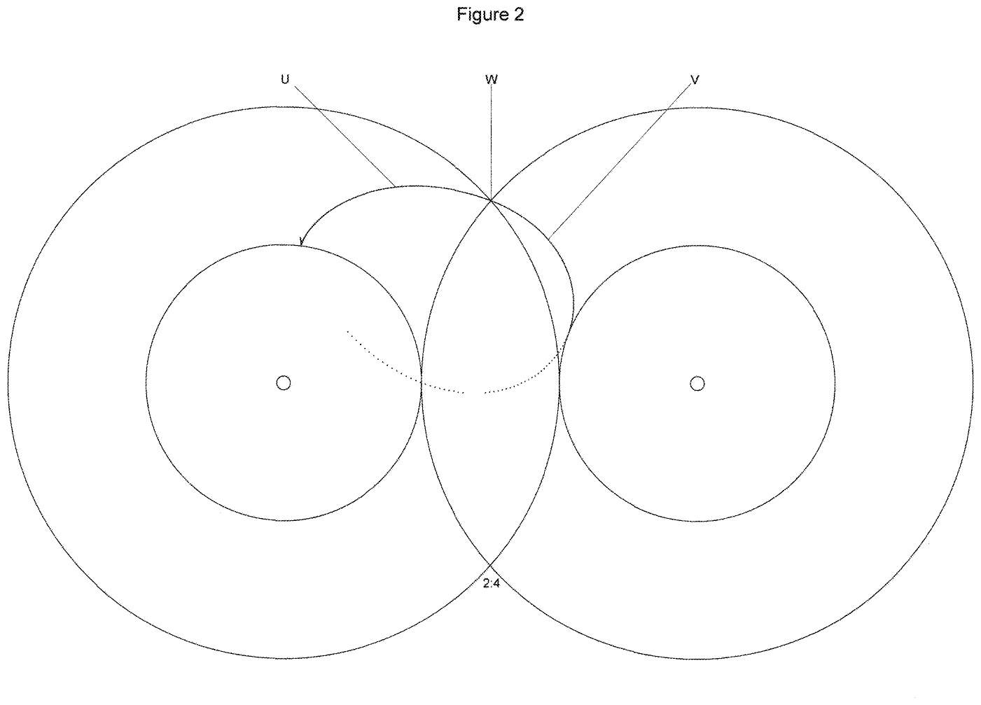

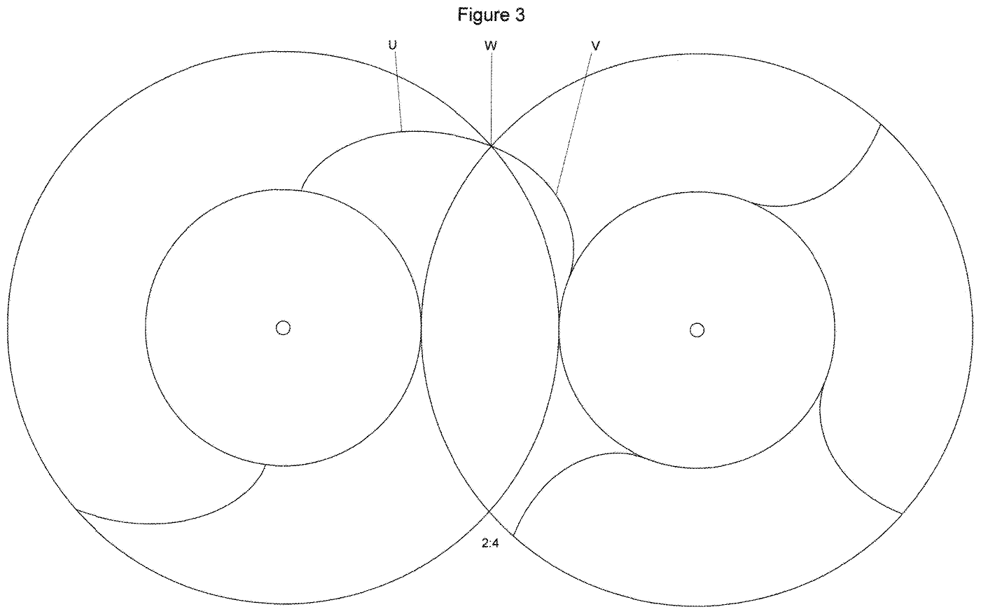

FIGS. 1 through 3 shows borrowed existing technology, where the trailing edge of the cross-sectional profile of a conventional two lobe screw can be mated with the leading edge of a conventional four lobe screw. In FIGS. 1 through 3, a dot is placed at W, where the outer circles intersect. This dot is attached to the right circle. Next, this right circle is spun at the appropriate speed ratio around the left circle where the dot is copied at equal periodic intervals thereby indicating the path for the curve U, FIG. 1. This path is traced in FIG. 2. This dot at W, FIG. 1 is then attached to the left circle. Next, this left circle is spun at the appropriate speed ratio around the right circle, where the dot is copied and equal periodic intervals thereby indicating the path for the curve V, FIG. 1. This path is also traced in FIG. 2.

The curves U and V are the only two curves that are borrowed from existing screw compressor technology and used in this invention. Since this invention is not about screw compressors, expanders or engines, the rotating members will hereafter be called rotors, not screws.

One novel portion of this invention involves the treatment of the leading edge of the two lobe rotor which mates with the trailing edge of the four lobe rotor. This novelty is created by using an elliptical arc for the leading edge of the 2 lobe rotor as shown in FIG. 4, 7, and FIG. 9. FIG. 4 demonstrates how the elliptical arc is created. Its major axis is the horizontal dashed line. The minor axis starts at the center c, FIG. 4, of the horizontal dashed line and extends downward until the ellipse meets the inside end of the trailing edge g, FIG. 4, at the junction f, FIG. 4, thereby creating the elliptical arc extending from f to b, FIG. 4; or J to I, FIG. 9.

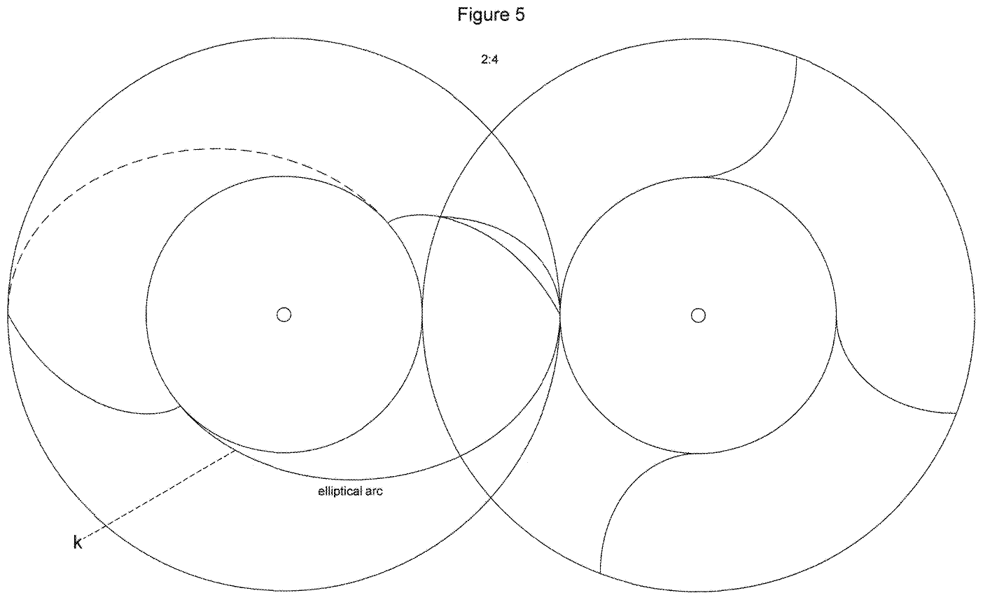

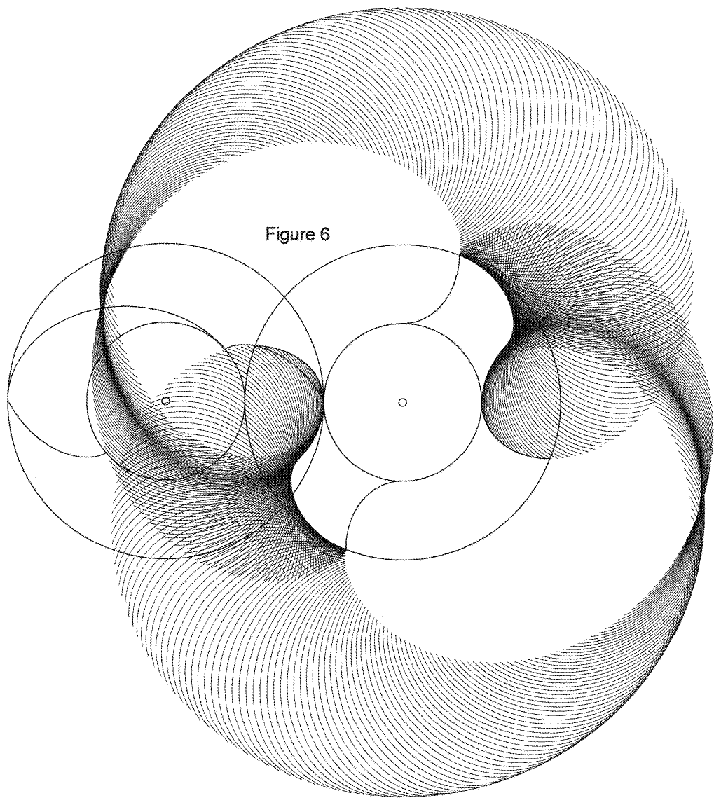

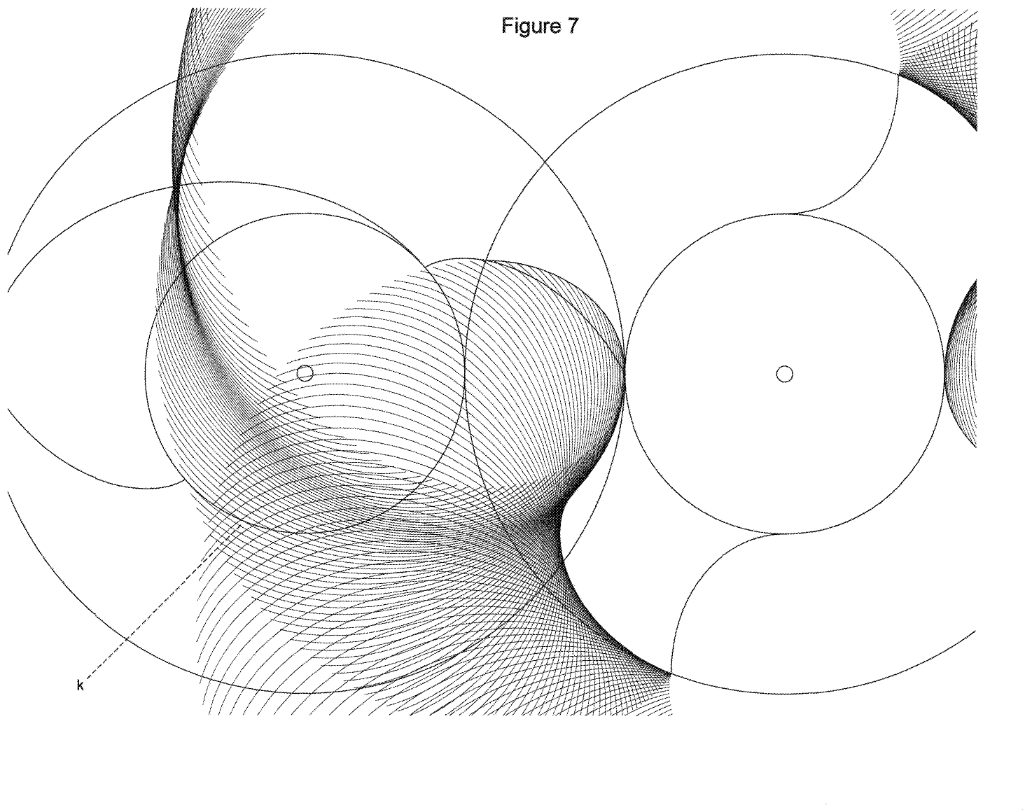

FIGS. 4 through 9 explain how to create the trailing edge of the 4 lobe rotor of a radial compressor or expander. In FIGS. 6 and 7, the elliptical arc of FIG. 4 is spun around the center of the planned 4 lobe rotor. The planned 4 lobe rotor is held stationary while the elliptical arc, which is a part of the 2 lobe rotor, is spun around the stationary 4 lobe rotor, while making copies at 1° intervals in order to create the trailing edge profile of the 4 lobe rotor. The leading edge k, FIG. 6, is the elliptical arc shown in FIG. 4

This elliptical arc, which uses the center of the two lobe rotor as its center, is spun around the center of the 4 lobe rotor, completing two revolutions while revolving once around the four lobe rotor. This elliptical arc is drawn for every 1° of rotation, as shown in FIGS. 6 and 7.

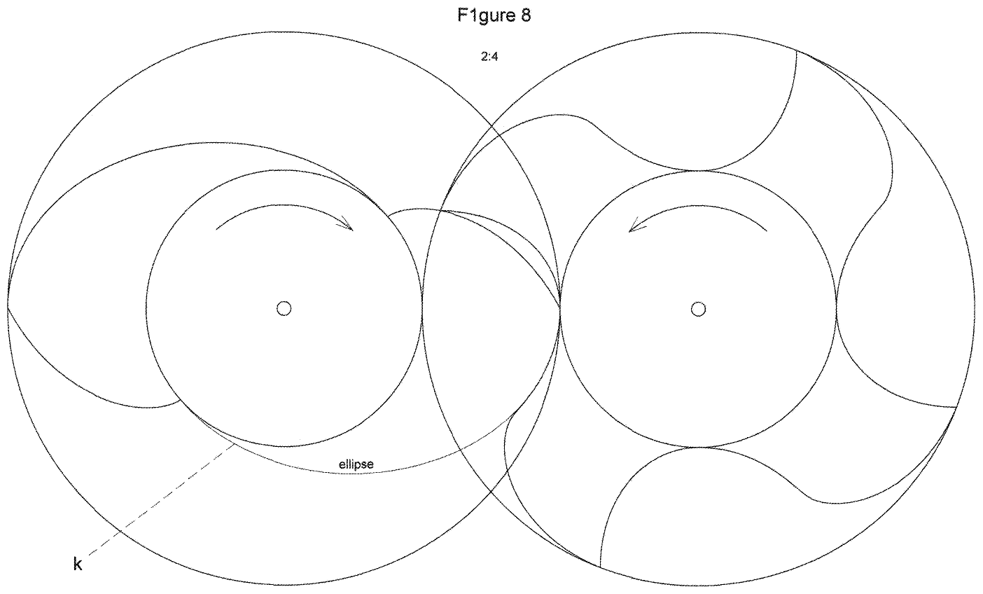

Studying the profile created by FIG. 6 and FIG. 7 reveals a profile of the trailing edge of the four lobe rotor. This trailing edge profile is copied from FIG. 6 or FIG. 7, and transferred to FIG. 4 and FIG. 8 in order to create the completed 4 lobe profile shown in FIG. 8.

This second novel portion of this invention compares the difference between screw compressors or expanders and axial compressors or expanders. This invention pertains to axial compressors or expanders, where the lobes are not twisted to form screws, as used in screw compressors but are aligned with the rotor axis. In other words, the lobes extend the full length of the shaft with no twist, thereby forming an axial compressor or expander.

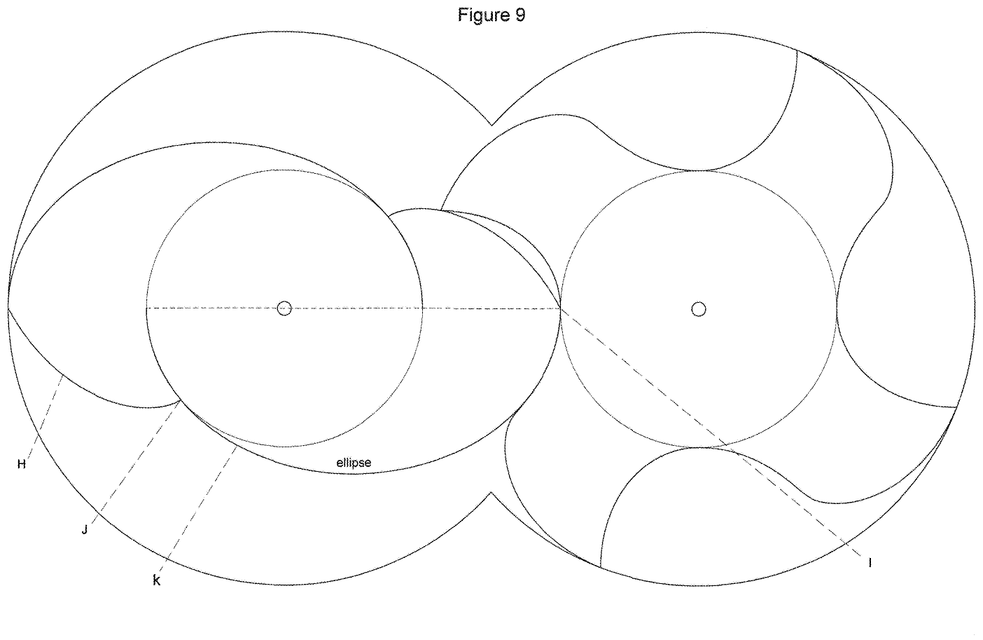

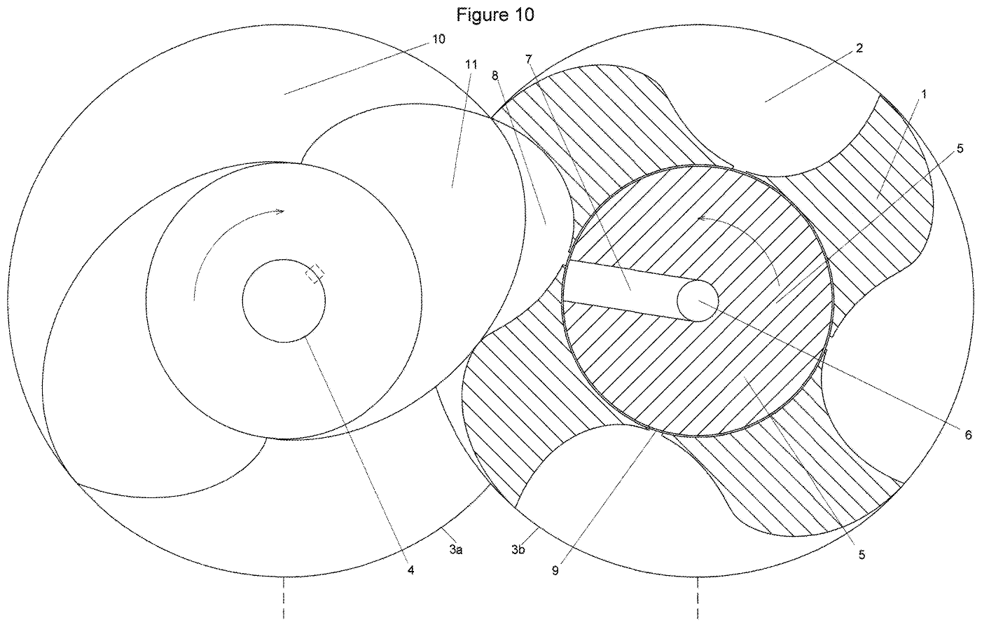

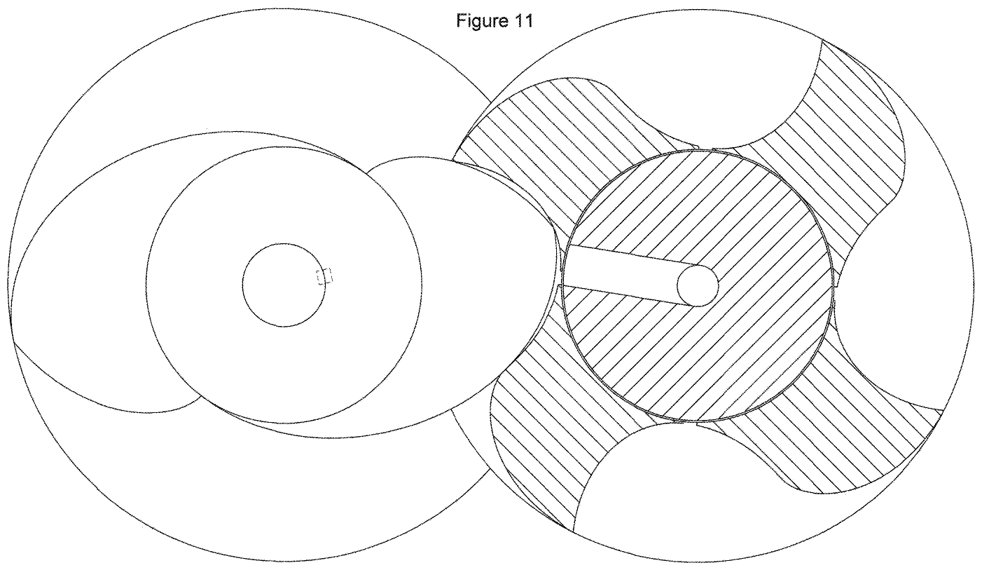

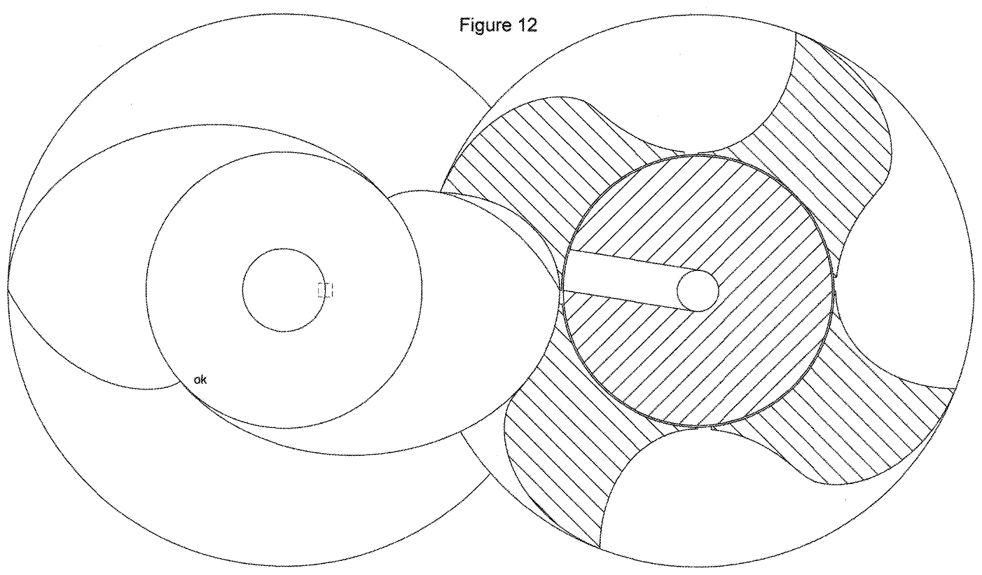

FIGS. 10 through 16 show how this axial compressor or expander works. Referring to the left half of FIG. 10, the two lobes with their hub and shaft at the left act as a single unit and rotate together as one piece. Referring to FIG. 10 again, the four lobe rotor on the right half consists of the four lobes 1, to which two circular flanges 2 are attached at both ends. The arc 3b defines the outside diameter of the flanges 2, while the arc 3a defines the minimum diameter of the stationary side wall 10. The flanges 2 are recessed into the stationary sidewall in order to allow the rotor lobes to mate properly.

The four lobes 1, FIG. 10, which are permanently attached to the flanges 2 rotate as a single unit around the large stationary shaft 5. This large stationary shaft 5 has an outside diameter slightly smaller than the inside diameter of the four lobe rotor described in the above paragraph, creating a clearance just wide enough to prevent contact. This large stationary shaft 5, FIG. 10 has a channel 7, FIG. 10 which feeds into to the high-pressure hole 6, FIG. 10.

FIGS. 10, 11, and 12 show how, when used as a compressor, gas is drawn from the low pressure side, then compressed between the two sets of lobes into cavity 8. Then this compressed gas, which is contained in the cavity 8, FIG. 10, is driven through the slot 9, FIG. 10, which exists between the lobes 1, then through the channel 7 of the stationary shaft 5, and finally into the high-pressure hole 6, FIG. 10.

The two sets of lobes referred to in the paragraph above, consists of the left set and the right set. The left set has two male lobes, while the right set has four female lobes. The maximum cavity volume for the left set, (2 lobe) appears on the top left of FIG. 10, and consists of the trailing edge of the top lobe, the leading edge of the bottom lobe, the two exposed fixed side faces 10, FIG. 10, and the exposed perimeter wall of the left section. The maximum cavity volume for the right section appears on the top right of FIG. 10, and consists of a trailing edge of the top left lobe of the right section, the leading edge of the top right lobe, the two exposed side flanges 2, and the two exposed perimeter walls.

When used as an expander, high-pressure gas coming through the high-pressure hole six, enters the channel 7, of the stationary shaft 5, FIG. 10 and through the slot 9 FIG. 10, which exists between the lobes 1, then into cavity 8, FIG. 10. This high-pressure gas in the cavity 8 FIG. 10 rotates both of the neighboring lobes apart, forcing the rotors to rotate opposite to the direction of the arrows in FIG. 10. This rotation causes the now expanded gas to be discharged into the low-pressure port (dashed lines) at the bottom of FIG. 10.

FIGS. 10 through 16 show how, when used as a compressor and rotated in the direction of the arrows, gas is drawn from the port at the bottom of FIG. 10, compressed between the lobes, then delivered through the slot 9, into channel 7, FIG. 10; then into the high pressure hole 6, FIG. 10, which feeds the high-pressure line, which is not shown in the drawing.

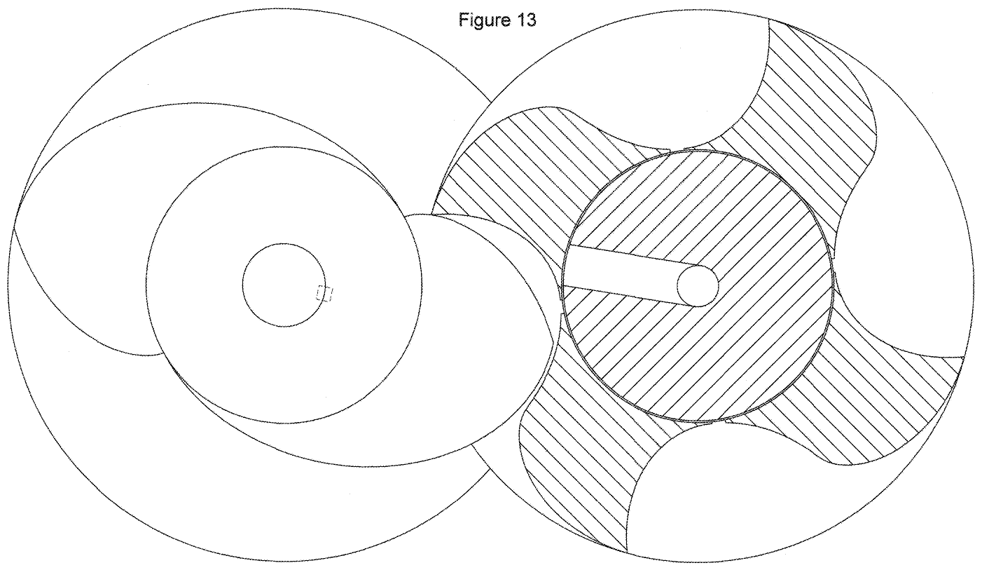

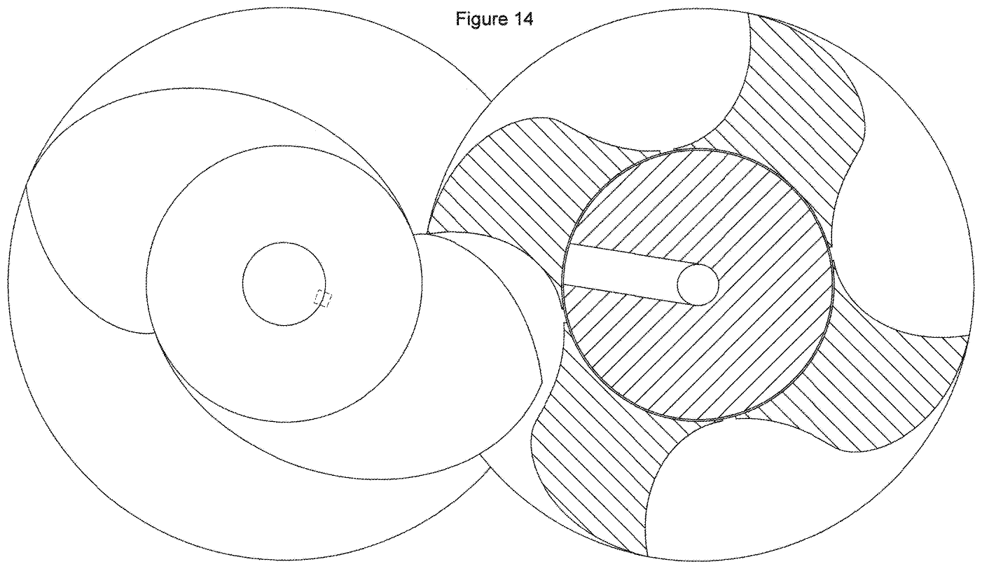

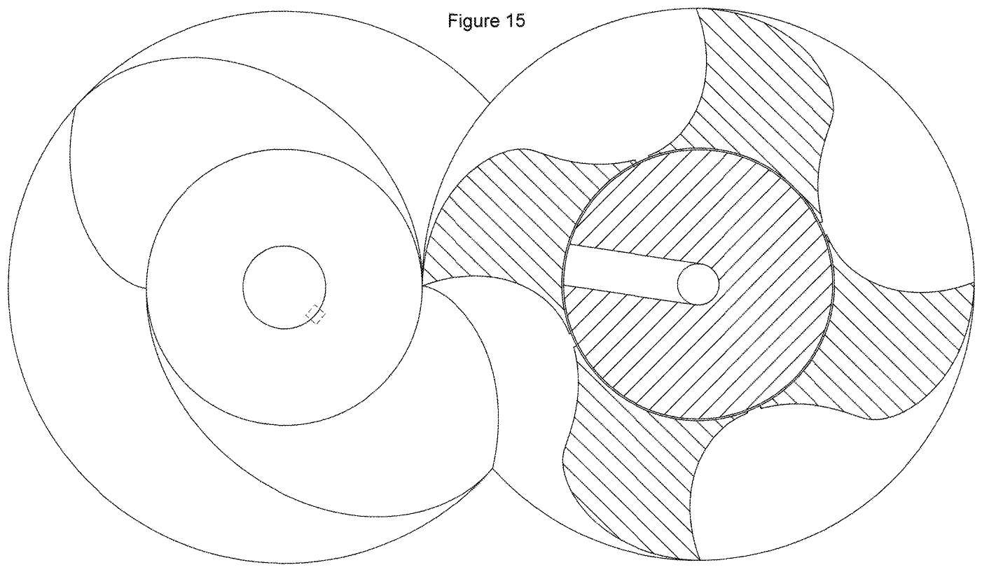

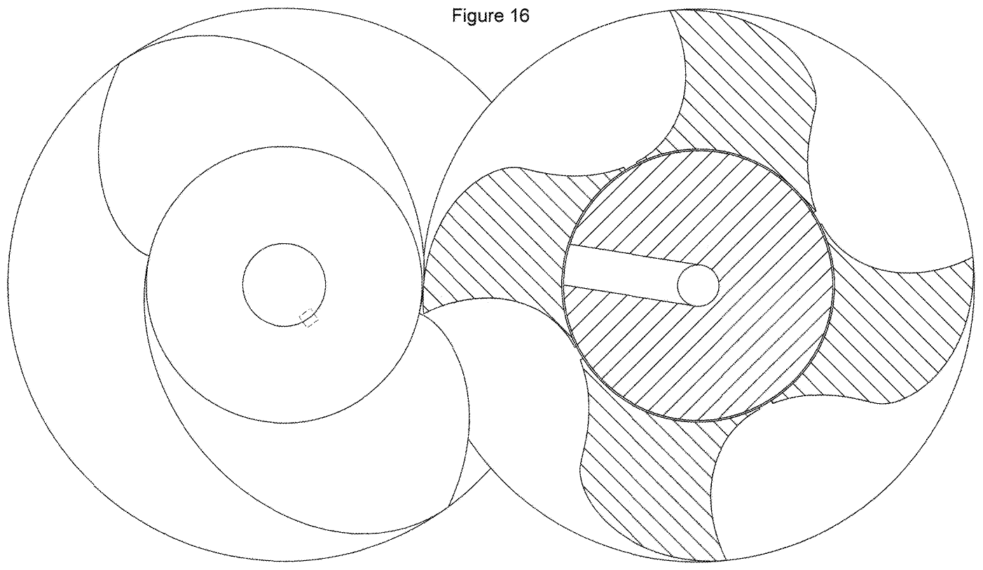

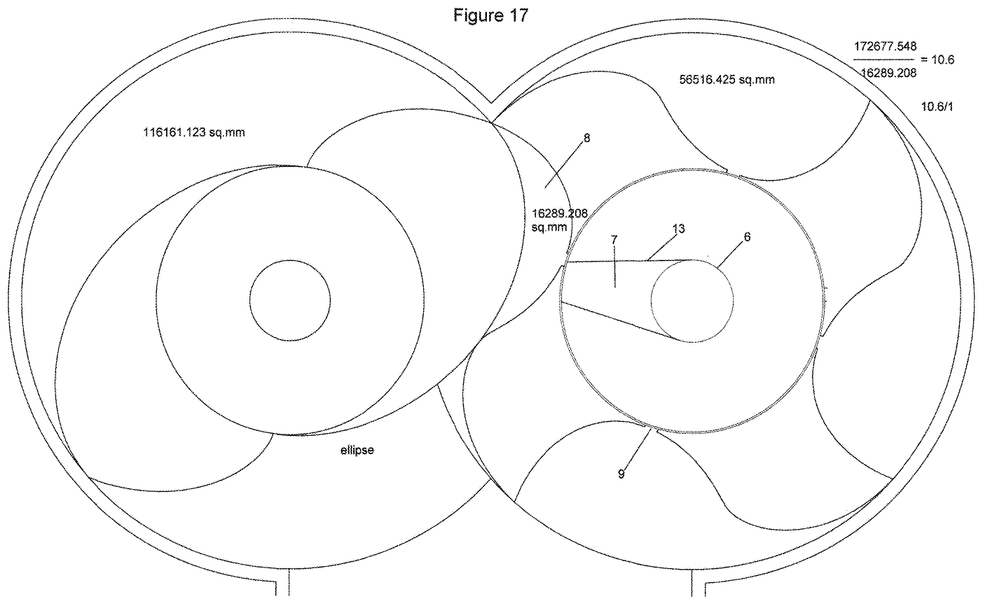

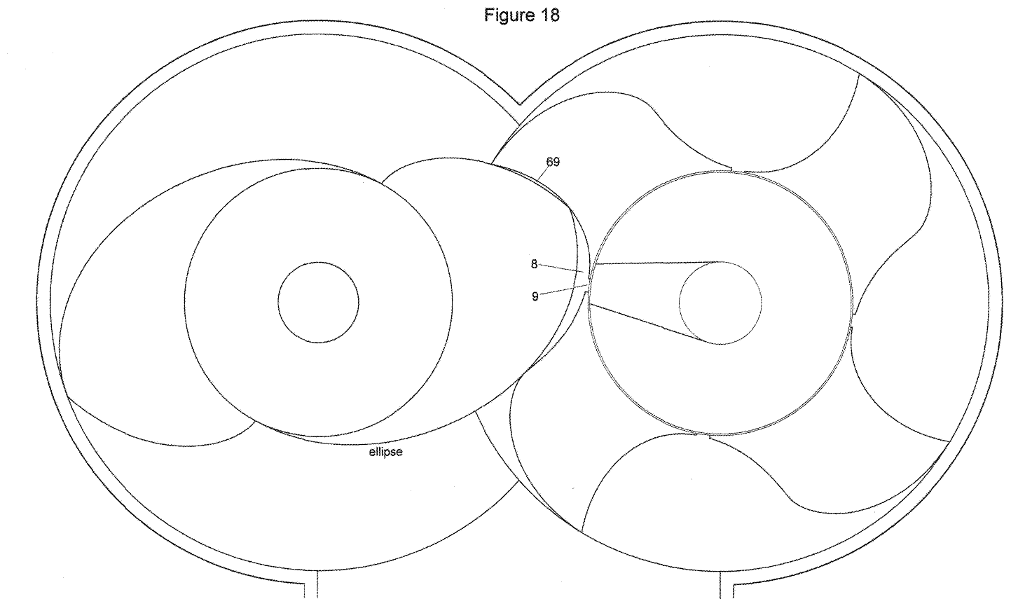

FIG. 17 shows how a perimeter wall can be designed to contain the cavities of this drawing and previous drawings. The area of the two upper cavities is divided by the area of the center cavity to calculate the compression ratio. This occurs at a time when the cavity 8 is beginning to provide an opening to the high pressure port 6, through the slot 9 and the channel 7. This compression ratio can be designed either higher or lower by rotating the line 13, FIG. 17 either clockwise or counter-clockwise around the high pressure port 6, FIG. 17. FIGS. 18 and 19 further explain how the gas in cavity 8 FIG. 17, is discharged into channel 7 FIGS. 17, 18, and 19.

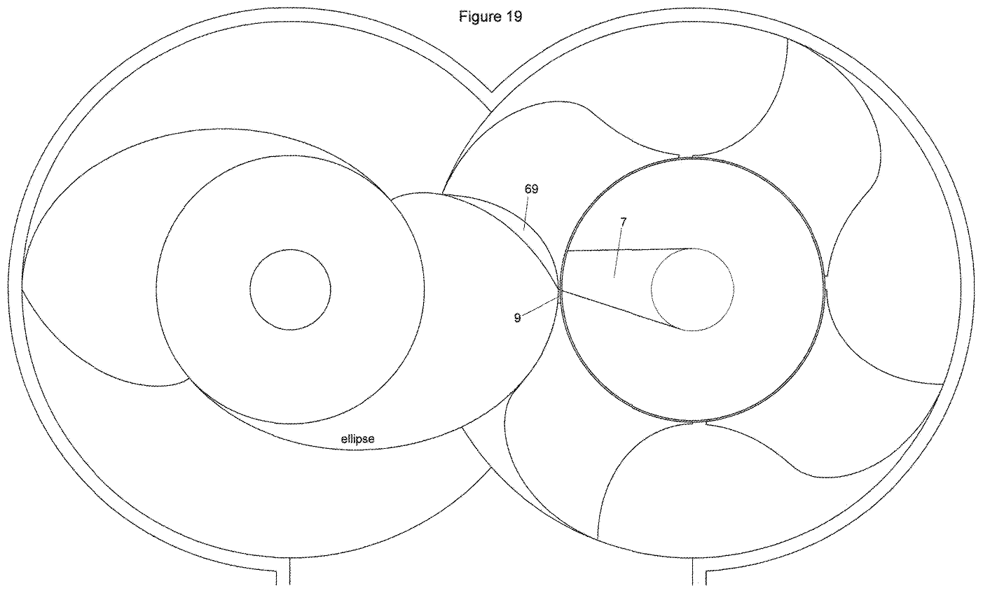

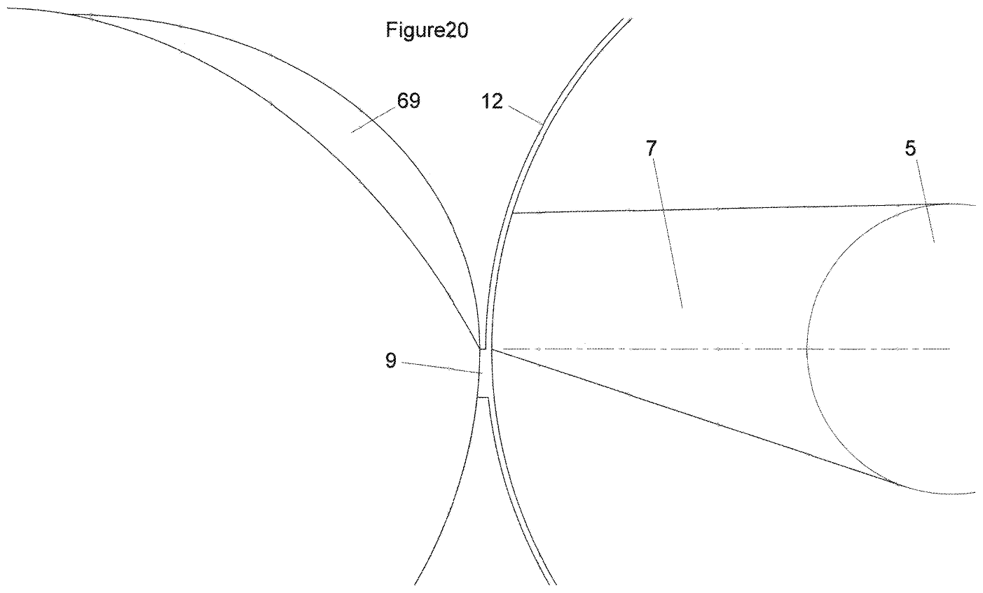

FIG. 20 is a magnification of FIG. 19 to show in greater detail the proper placement of the slot 9 of FIG. 19. Referring to FIG. 20, when the narrower upper line of slot 9 is in line with the centerline that joins the rotor centers, the gas flow is stopped. The wider lower line of the slot 9 can be adjusted up or down to provide just enough slot opening for the compressed gas contained in cavity 8, FIG. 10 to be transferred through the slot 9 FIG. 20, into the channel 7 FIG. 20, without excessive resistance to the gas flow. The reason why the slot opening must be kept small as possible is because the gas contained in the area between the upper and lower lines of slot 9 continues downward until it empties into the low pressure area, thereby losing a small amount of the energy that was created to compress the gas. Therefore, it becomes necessary to reduce the area contained in slot 9 as much as possible.

The narrower upper line of slot 9 FIG. 19; and also shown in the enlarged FIG. 20, must be in line with the centerline between the rotor centers when the rotors are as shown in FIG. 19. This is necessary because the wall of the right rotor lobe directly above slot 9 must be brought all the way down to the centerline in order to prevent high-pressure gas in channel 7 FIG. 19 and FIG. 20, from escaping into the cavity 69, FIG. 20.

Any gas that would escape into cavity 69 would continue downward until empties into the low-pressure area, thereby losing some of the energy that was created to compress the gas.

The diameter of the circle 12 (4 lobe inside diameter), and the outside diameter of the stationary shaft 5, FIG. 20 needs to be adjusted in order to create a wall strong enough to prevent any damage where the lobe wall Is the weakest, (just above the upper line of Slot 9), and also keep the diameter of the circle 12 FIG. 20 as great as possible in order to keep the area of the slot 9 FIG. 19 as small as possible.

Triple Rotor Compressor, Expander, or Engine

FIGS. 21, 22, and 23 show how, with the addition of another identical 2 lobe rotor on the right side, this compressor or expander can have its capacity doubled. The perimeter walls would be arranged as shown in FIGS. 21, 22, and 23. The two low-pressure ports, FIGS. 21, 22, and 23, of which one is on top of the drawing, with the other on the bottom of the drawing, would most likely be joined together externally, to form one common low-pressure port.

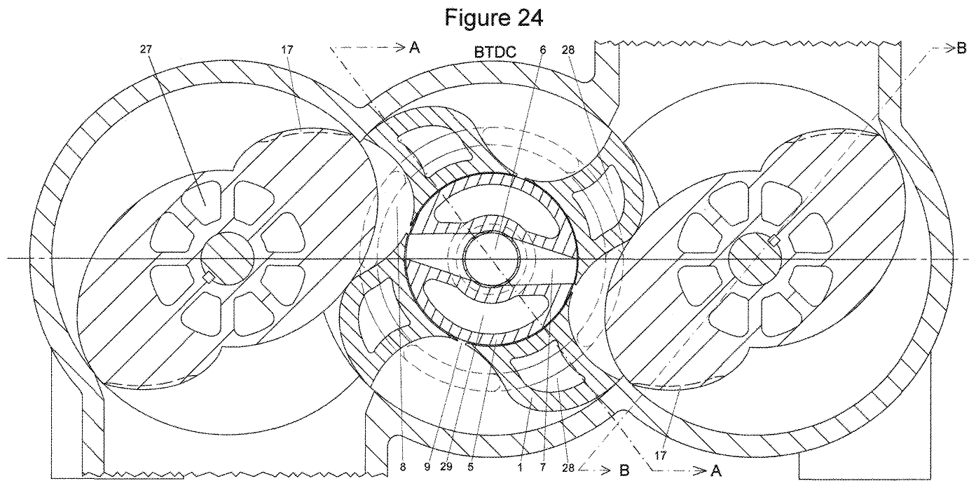

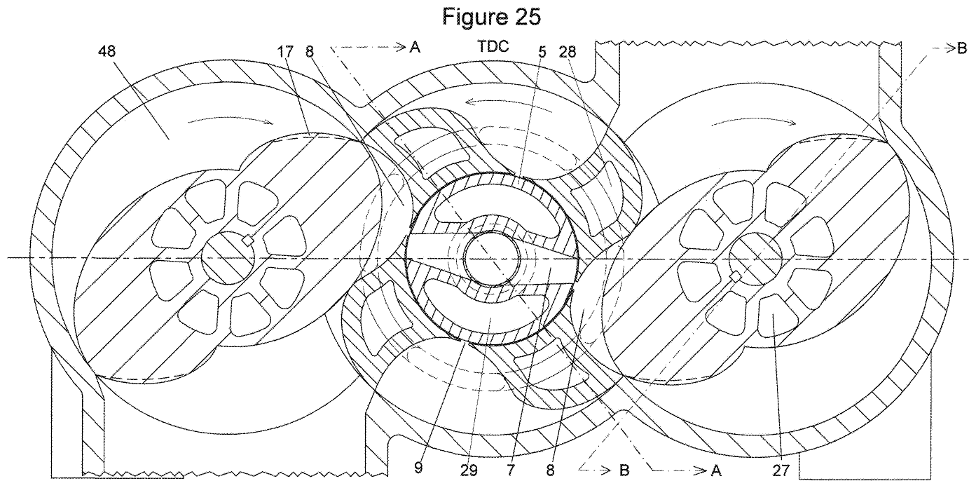

FIGS. 24 and 25 show how such a triple rotor compressor or expander can be cooled by blowing cooling air through the channels 27 and 28, FIGS. 24 and 25 created within each of the three rotors. Cooling channels 29 FIGS. 24 and 25, are also provided through the stationary center shaft 5, FIGS. 24 and 25.

The 2 lobe rotors both rotate clockwise when used as a compressor, as shown in the drawings of FIGS. 24 and 25, while the flanged center rotor rotates counter clockwise in the same drawings. The center flanged rotor rotates at half the speed of the two end rotors. When used as a compressor, gas trapped between the lobes of the two outer rotors are compressed and driven into the cavity 8 FIGS. 24 and 25.

There is a slight difference between FIGS. 24 and 25. FIG. 24 shows a position where the 4 lobe rotor lobe tips have not yet reached the point where these tips almost touch the 2 lobe rotor lobe tips, while FIG. 25 shows a slightly rotated position where these tips are almost touching, being separated only by the necessary clearance, which is designed in. In FIG. 24, when used as a compressor, compressed gas remains contained in the cavity eight, while in FIG. 25, two of the slots 9 FIGS. 24 and 25 are now opening, allowing compressed gas contained in cavities 8 to be pushed into the channels 7, and from there into the discharge high-pressure port 6, FIG. 24.

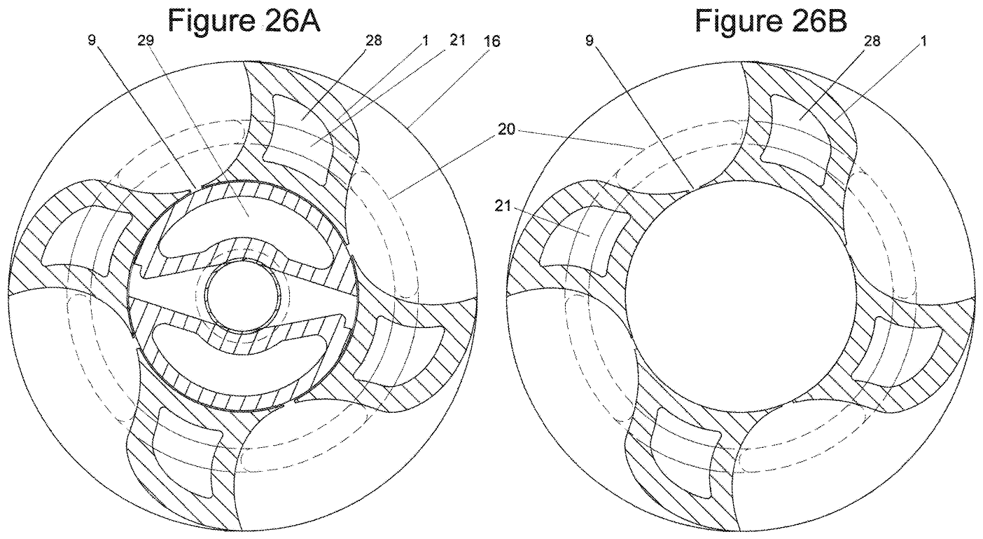

The drawing of FIG. 26A shows the 4 lobe rotor with its attached rear flange 16. The front flange (not shown) is identical to the rear flange. The flanges and the lobes can be fastened together in the conventional manner, or the lobes with their flanges can be manufactured as one single part. The drawing of FIG. 26A also shows the four lobe rotor properly positioned over the stationary shaft. The drawing of FIG. 26b shows this 4 lobe rotor assembly without the stationary shaft.

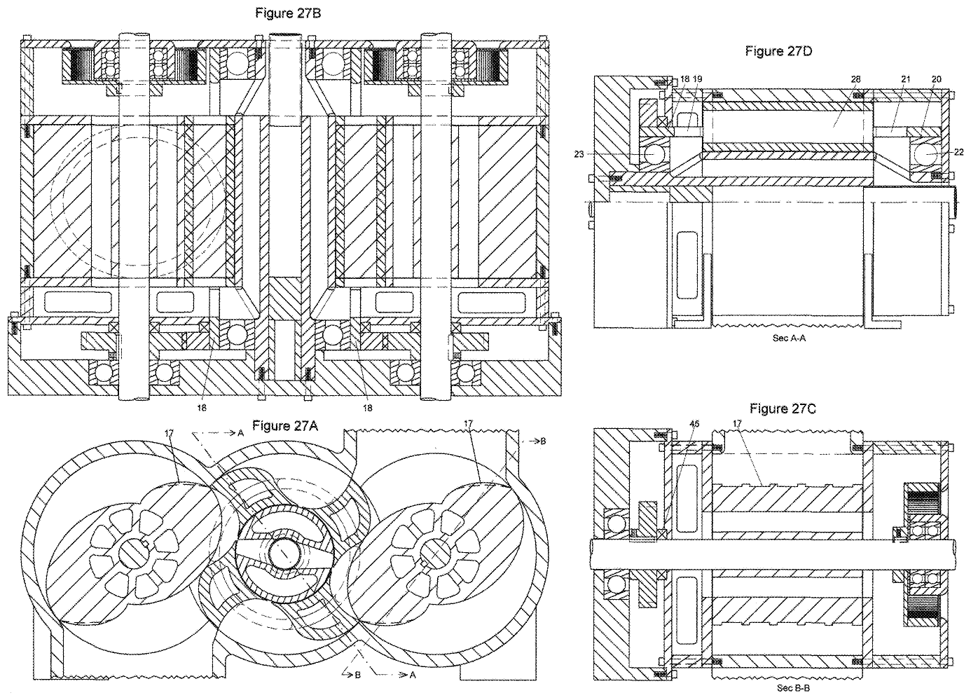

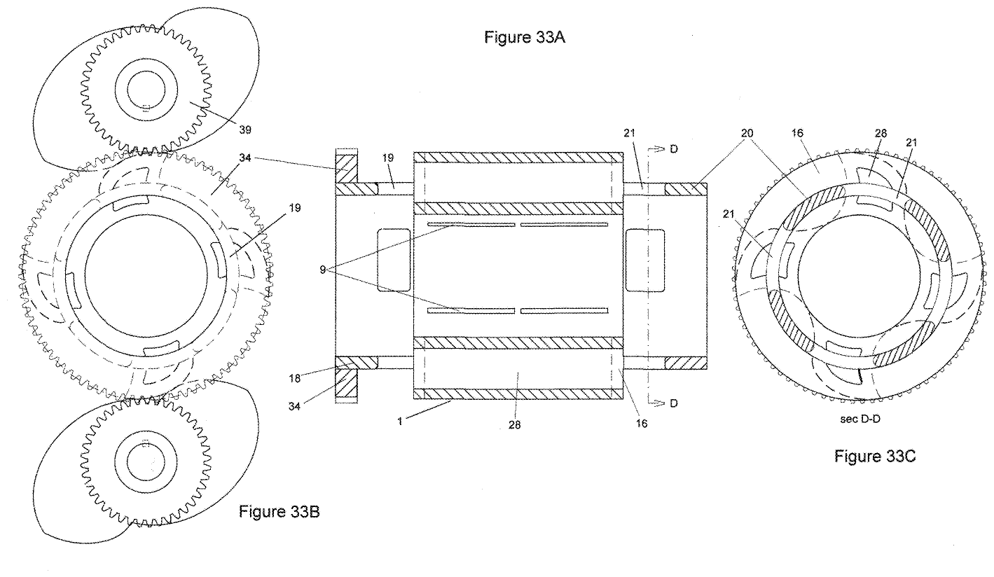

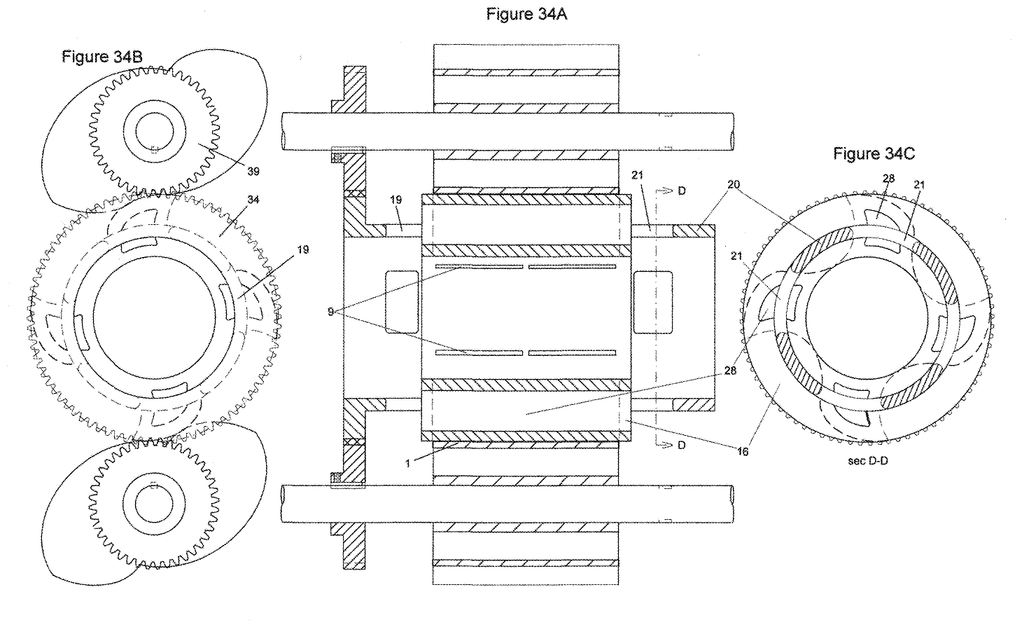

The cylinder 20, which has slots 19 in it to admit cooling air through them, FIGS. 26A, 26B, 33A and 33C is either attached to the end of, or is preferably a fixed part of the four lobe rotor (also see FIG. 33A). The inside diameter of the slotted cylinder 20, FIGS. 26A and 26B, like the cylinder 18, is sized to fit over the outside diameter of the bearings 22 and 23, FIGS. 27D and 28B. The slots 19 and 21 provided in cylinders 18 and 20, FIGS. 27D and 28B permit cooling air to pass through these slots in order to feed cooling air through the channels 29 of the stationary shaft.

FIGS. 27A and 28A are the same drawing as FIG. 25. FIGS. 27B and 28B are the same drawing as FIG. 29. They are repeated for better comprehension. FIG. 27B is a top view of FIG. 27A. FIG. 27C is a right side view of FIG. 27A taken through section B-B of FIG. 27A. FIG. 27d is a right side view of FIG. 27a, taken through section A-A of FIG. 27A. FIG. 27B is a top view of FIG. 27A.

FIG. 28A and FIG. 28B will be used to describe the air cooling system. Two blowers, 24, FIG. 28B, which are attached to the shafts of the two lobe rotors, FIG. 28B, draw air through the intake 25 FIG. 28B, discharging this air into the Plenum 26, FIG. 28B, thereby putting the Plenum under positive air pressure. Air from the pressurized Plenum 26, FIG. 28B, is driven through the air cooling channels 27, FIGS. 28A and 28B, which have been created within both 2 lobe rotors 11 FIGS. 28A and 28B. After leaving the air cooling channels, this cooling air enters the Plenum 30, FIG. 28B, then discharges through the openings 31, FIG. 28B, which are installed in the perimeter wall of the Plenum 30.

Air from the pressurized Plenum 26, FIG. 28B, is also driven through the air cooling channels 28, FIG. 28B, which have been created within the lobes of the four lobe rotor 1, FIG. 28A and FIG. 28B. After leaving the air cooling channels, this cooling air also enters the Plenum 30 FIG. 28B, and exits through the openings 31, FIG. 28B.

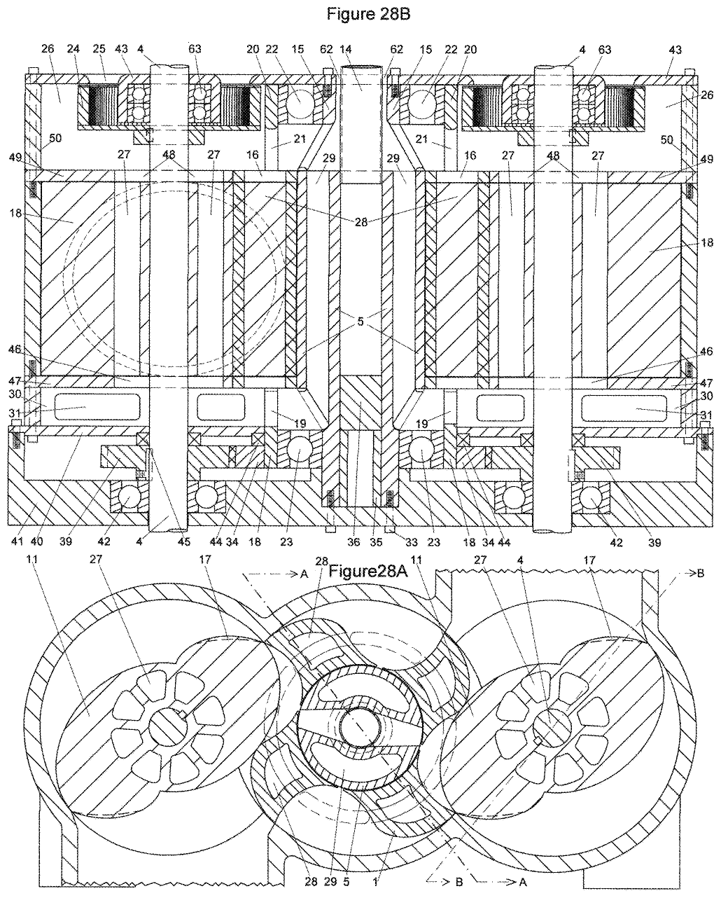

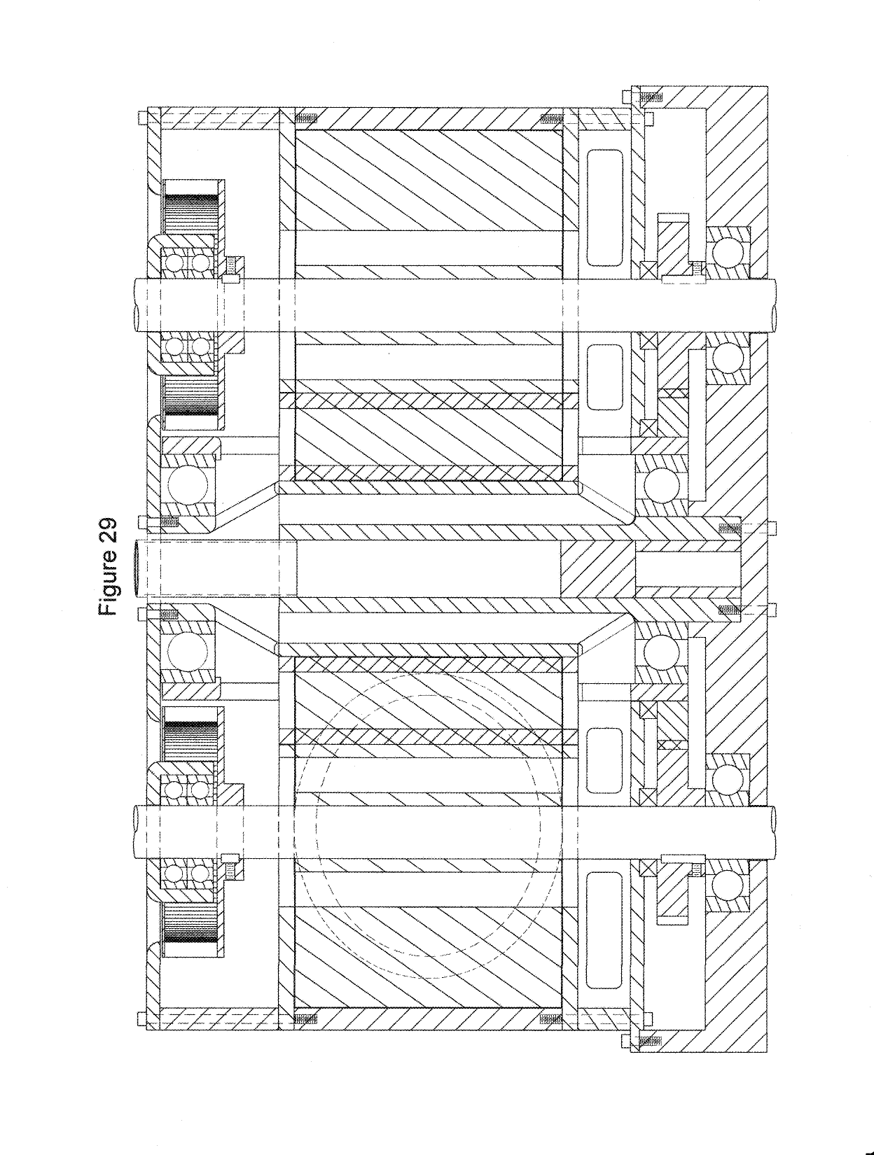

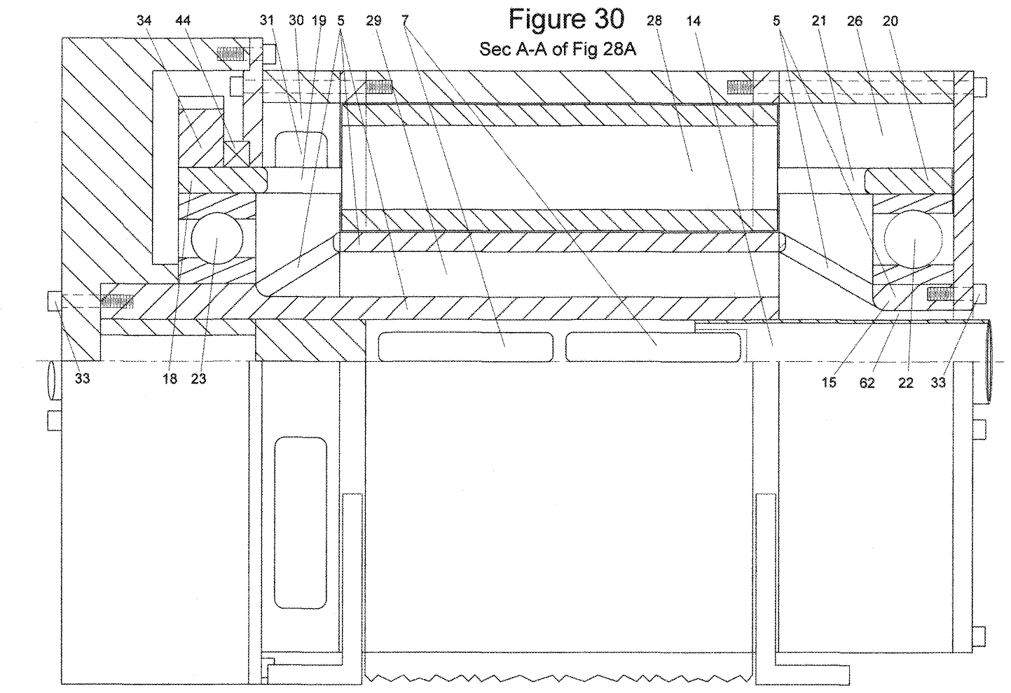

FIG. 29 is an expanded view of FIG. 28B. The lower half of FIG. 30 shows a right side view of FIG. 28A, while the upper half of FIG. 30 shows a cut taken through the center of the upper half of the machine in 28A. In this upper half, the upper part of the stationary shaft 5 FIG. 24, is shown.

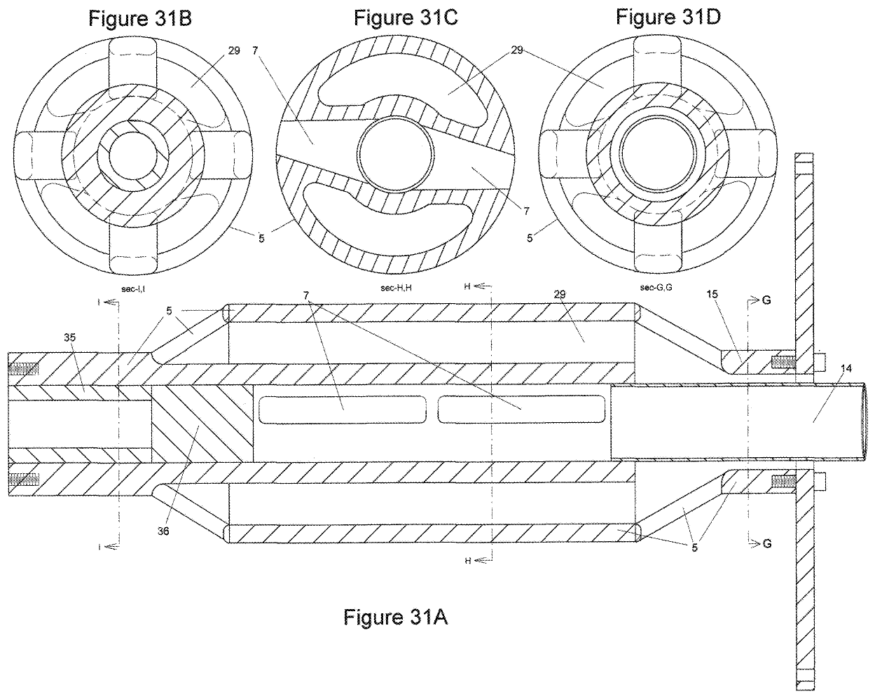

In FIG. 30, air from the blower pressurized Plenum 26, FIG. 28B and FIG. 30, pass through and behind the air cooling slots 21, FIGS. 26 and 30, which are provided in the blower end slotted cylinder 20 FIG. 30; then through the air cooling channels 29, FIGS. 30 and 31A created in the stationary shaft 5, FIGS. 30, 31A, 31B, 31C and 31D, From there, this pressurized air passes upwards through the air cooling slot of the gear end slotted cylinder 18, and into the Plenum 30, where the cooling air exits through the openings 31, FIGS. 28b and 30.

Also in FIG. 30 an additional amount of air travels from the blower pressurized Plenum 26, FIG. 28B and FIG. 30, through the slots provided in the stationary shaft 5 FIG. 30. This small amount of air passes through the cooling air gap 62 provided between the hot high-pressure air pipe 14, FIGS. 28B and 30, and the stationary shaft bearing support 15, FIG. 28B and FIG. 30, which is a portion of the stationary shaft 5; thereby preventing overheating of the bearing 22 FIGS. 28B and 30.

Also shown in FIG. 30 is the upper part of the center timing gear 34, FIG. 30, with its seal 44, FIG. 30. The four lobe rotor with its gear 34 is supported by the bearings 22 and 23, FIG. 30. These bearings are supported by the stationary shaft 5, FIG. 30, which are anchored in place by the bolts 33.

The figures of 31A to 31D show the stationary four lobe shaft in its entirety, along with 3 sectional cuts. The bore of this stationary shaft 5 FIG. 31A to FIG. 31D, has a sleeve 35 and a plug 36 at its gear or left end. The objective of this sleeve and plug is to prevent hot high-pressure gas from exiting at this end. The right end of the bore of this stationary shaft has the high-pressure pipe 14 installed within it.

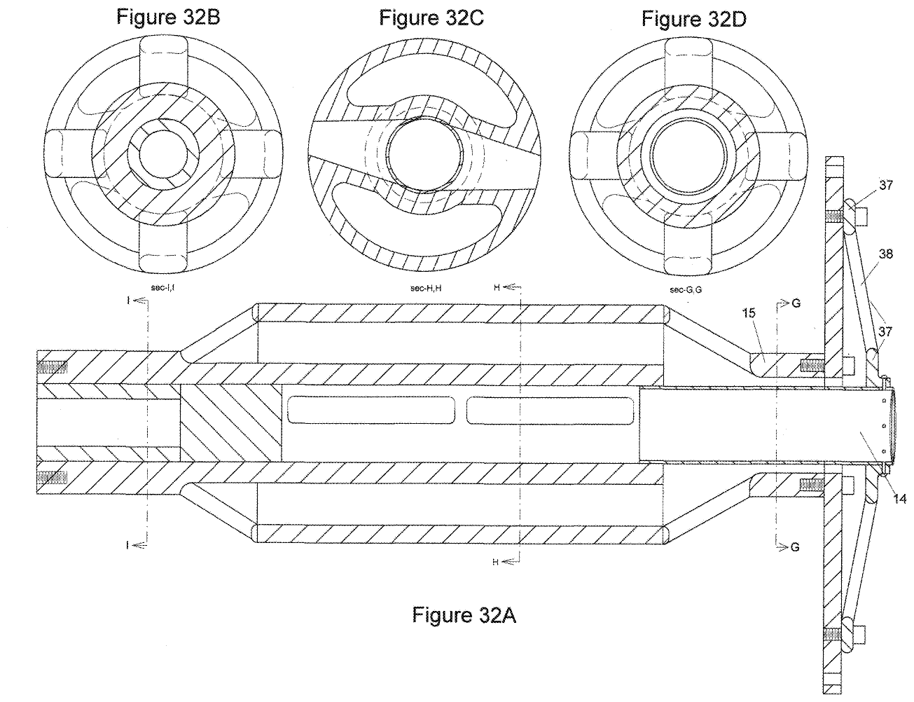

FIG. 32A is identical to FIG. 31A except for the addition of a high-pressure pipe supporting structure 37, FIG. 32A. The addition of this structure is necessary because the high-pressure pipe is often too hot to come into contact with the bearing support 15, FIG. 31A. Physical contact of the hot high-pressure pipe against the bearing support 15 would likely transfer enough damaging heat from the high-pressure pipe through to the bearing support 15, FIG. 32A, and into the bearing 22, FIG. 30. The high-pressure pipe supporting structure 37 FIG. 32 has openings 38 provided within it in order to allow pressurized cooling air to escape through it.

FIG. 33A shows the four lobe rotor assembly, complete with left end and right end sectional views. The large gear at the left end (FIG. 33B) of the assembly engages the 2 smaller gears attached to both 2 lobe rotors. Also shown are the slots 9, FIGS. 33B, 26A and 26B, through which compressed gas in cavity 8, FIG. 24, is driven into the channel 7, of FIGS. 24. Slots 19 and 21, FIG. 33B, are provided on both sides of the lobes in order to allow cooling air to pass through them.

FIGS. 34A and 34B show the relationship between the two lobe rotors and the four lobe rotor. The gear train is shown on the left. A right end view, FIG. 34C, taken through section D-D is shown on the right. FIG. 34A shows the location of the cooling air slots 21 and 19, FIGS. 28B and 33A.

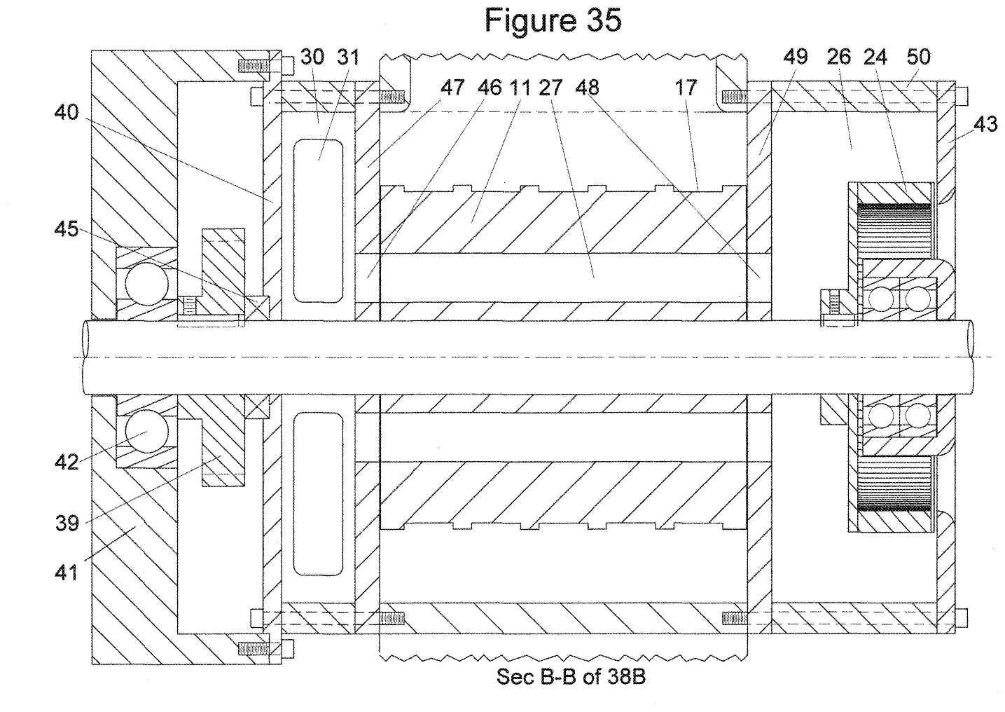

FIG. 35 shows a cross-sectional view of section B-B in FIG. 24. Starting from left to right in FIG. 35, the gear case 41 and its back plate 40 enclose the gear end bearing 42, the gear 39 and the seal 45. Continuing to the right in FIG. 35, the cooling air plenum 30 contains the slots 31, through which the cooling air exits.

Starting from the right in FIG. 35, air enters the cooling fan 24 through the air intakes in the cover plate 43, FIGS. 35, 38A and 39A. The rotating fan 24, FIG. 35 discharges this air into the cooling air Plenum 26, FIG. 35, putting this Plenum under pressure. This pressurized air is then driven through the side plate slots 48, then through channels 27 of the two lobe rotor 11, FIG. 35, then exits through the slots 46 in the side plate 47, then into the cooling air Plenum 30, from which this cooling air exits the machine through the slots 31, FIG. 35.

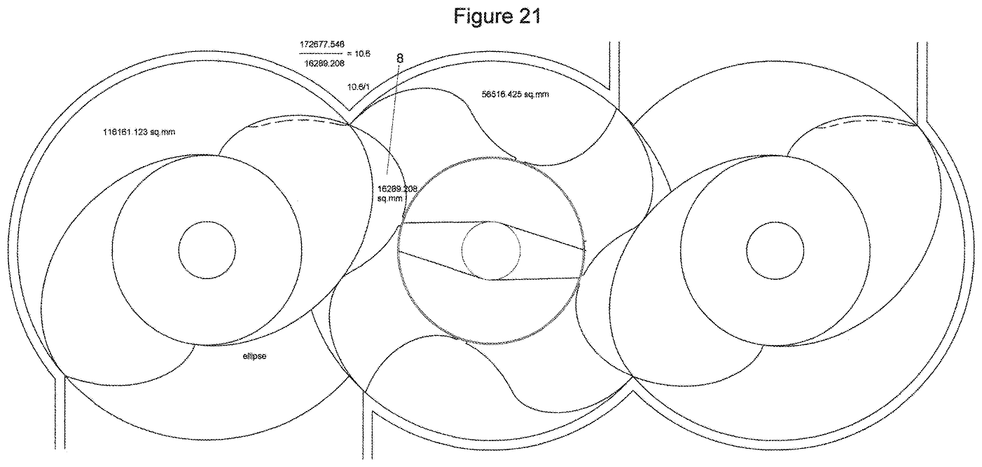

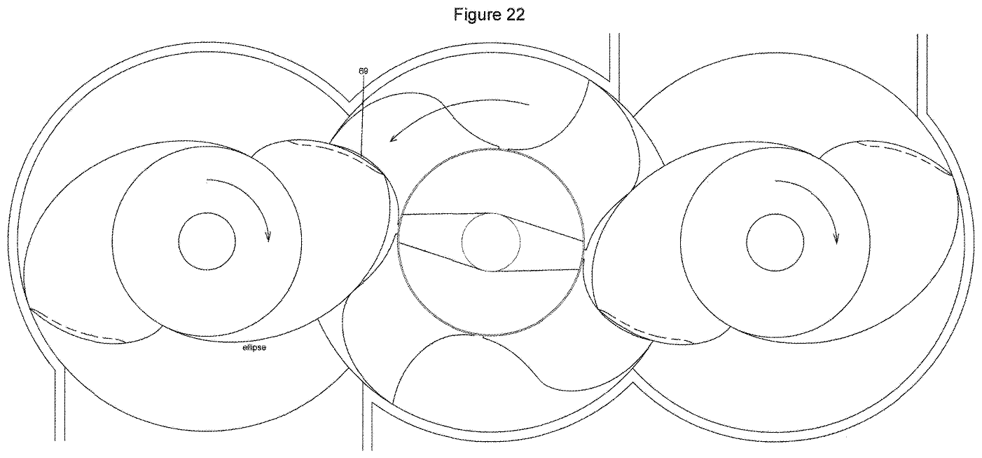

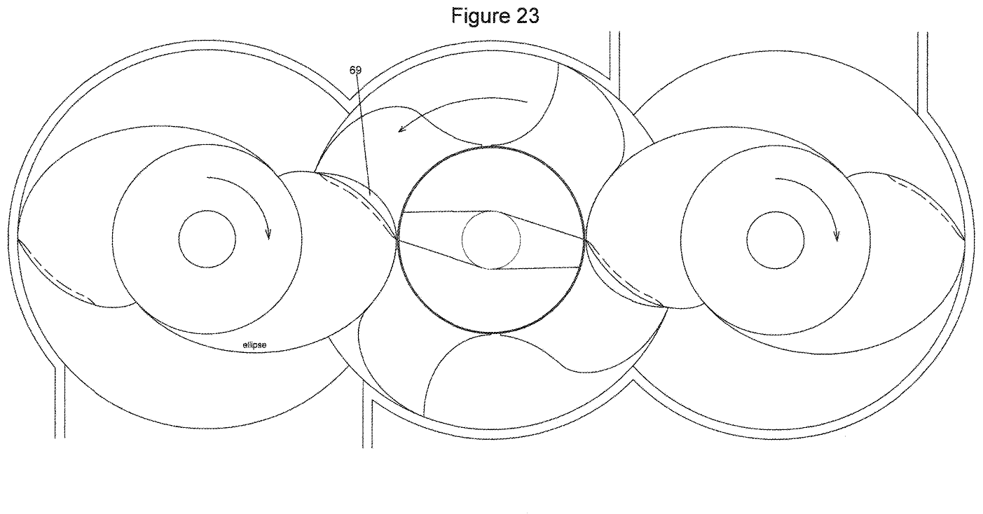

The 2 lobe rotors 11, FIGS. 25 and 35, have shallow grooves 17 cut into a small portion of their periphery as shown in FIGS. 24, 25 and 35. The purpose of the shallow grooves is to allow a small amount of low pressure air into the cavity 69, FIGS. 22 and 23, to relieve the vacuum in the Cavity 69, FIGS. 22 and 23. These grooves are created for a short distance as the rotors rotate forward to the position shown in FIG. 23. The length of these grooves are designed just long enough so that when the rotors are in the position as shown in FIG. 23, the cavity 69, FIG. 23, will have the same gas pressure within it as that of the low pressure port. This assures that there will be no energy loss when the cavity 69 empties into the low-pressure port.

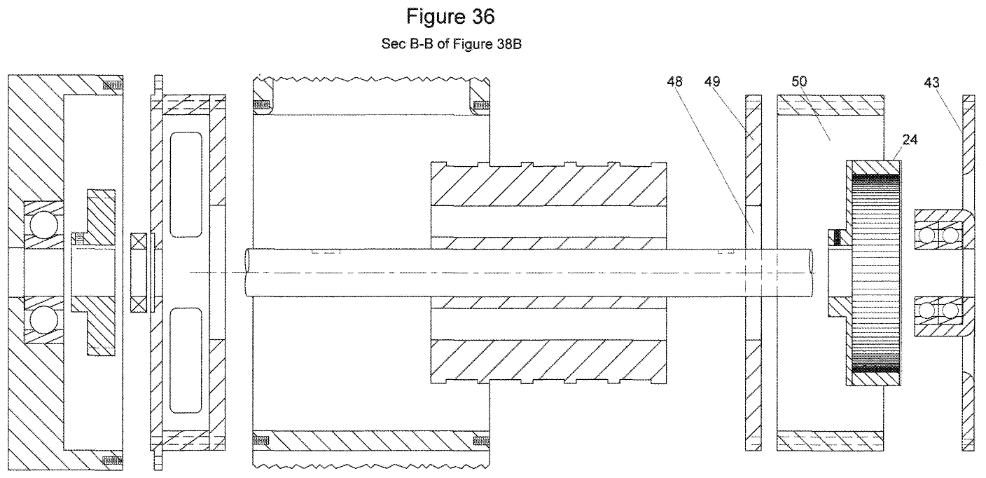

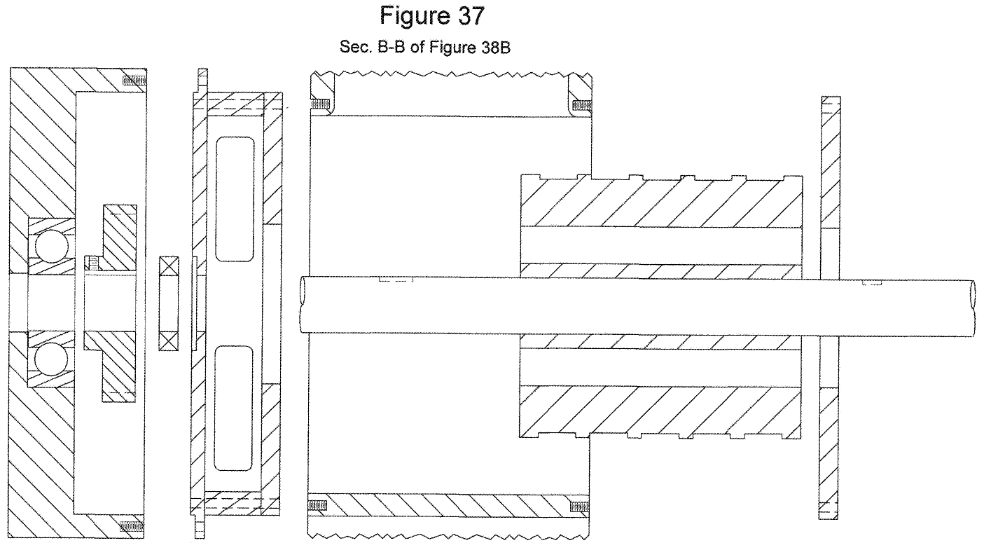

FIGS. 36 and 37 are similar. FIG. 36 shows one of the two lobe rotors complete with all of its parts, starting from the gear case 41 at the left to the cover plate 43 at the right. FIG. 37 shows a larger view with the fan 24, the cover plate 43, and the Plenum housing 50 removed.

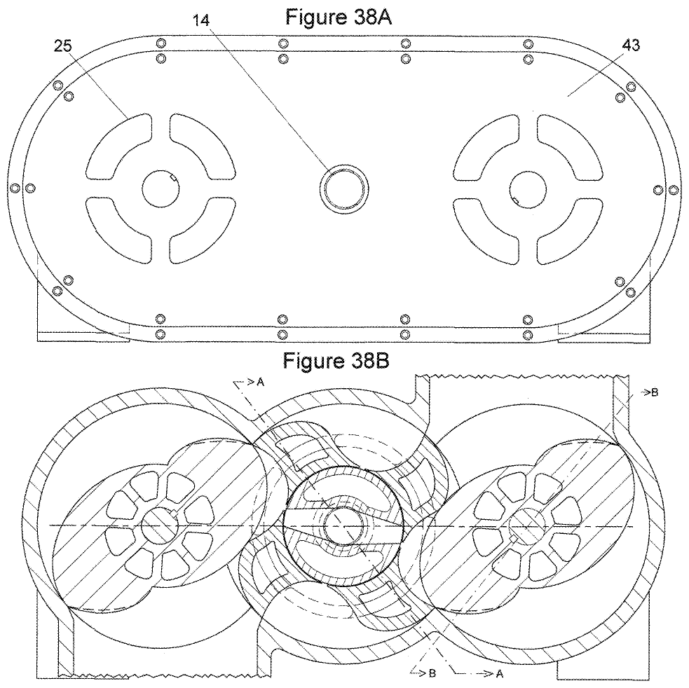

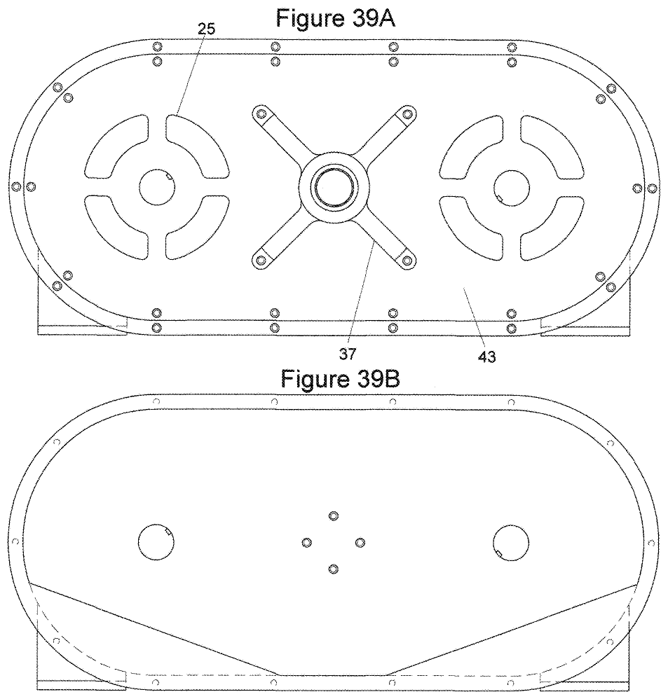

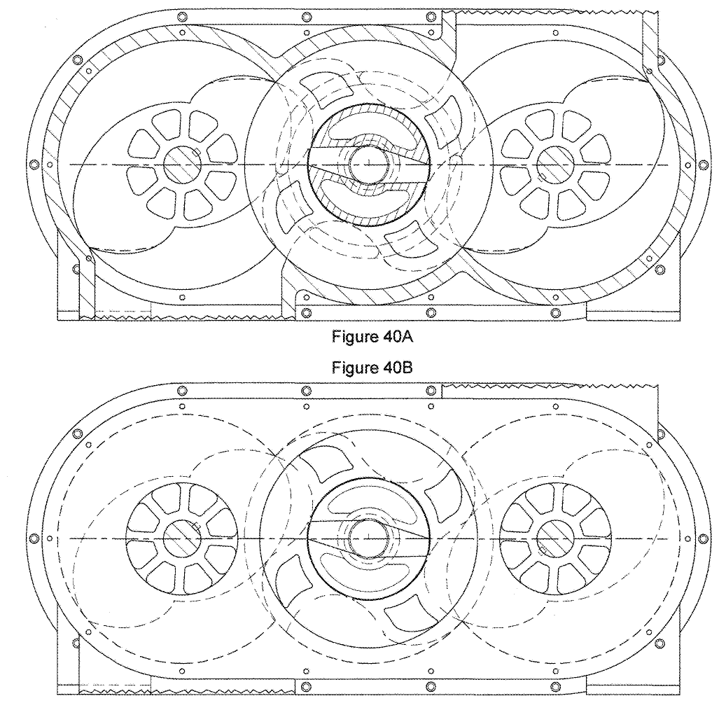

FIG. 38B is a repeat of FIG. 25. FIG. 38A shows the cover plate 43, the air intake ports 25, and the high-pressure gas pipe 14 in the center.

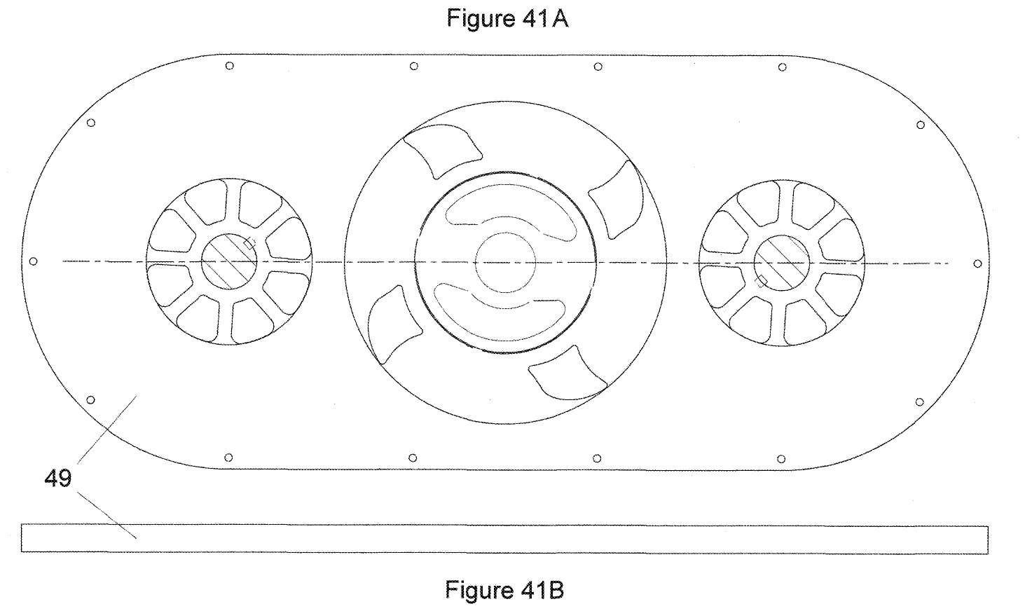

In FIG. 39B, an outside view of the gear case with its protruding two lobe shafts is shown. FIG. 39A shows an outside view of the cover plate 43, and the high pressure gas pipe support structure 37, FIGS. 39A and 32A.

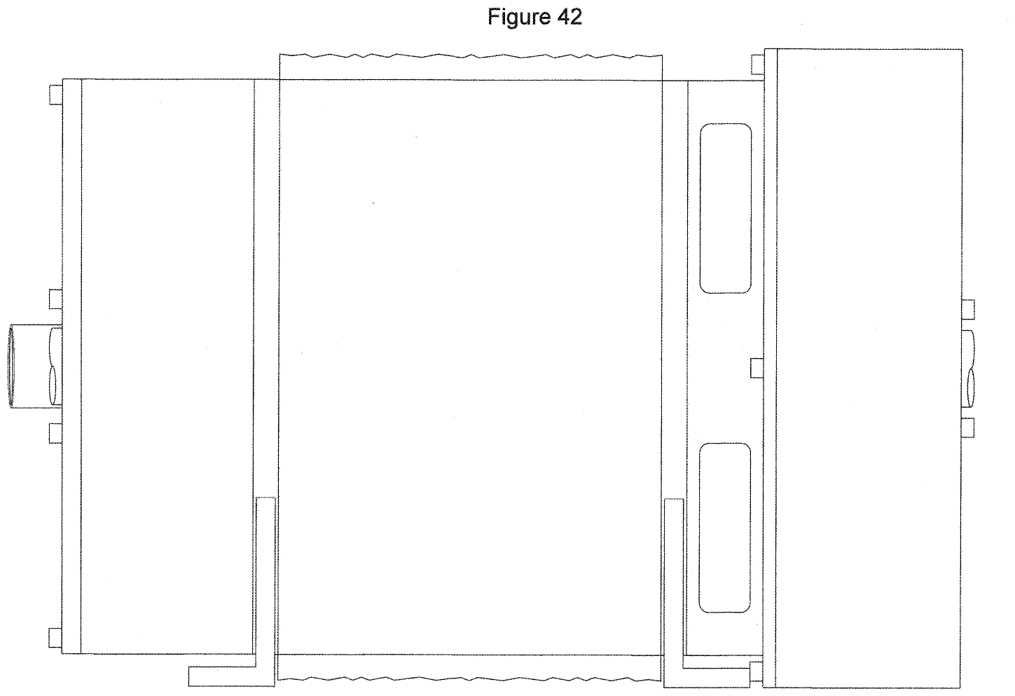

FIGS. 40A, 40B and 41A are included to show more clearly how the blower end side wall, which contain 3 large cooling air feed holes (openings) which feed only cooling air into the cooling air slots in the 3 rotors, and also feed only cooling air into the cooling air slots in the stationary shaft. These 3 large cooling air feed holes (openings) are shown as the 3 larger circles within FIG. 41A. FIG. 40A shows the rotors ready for installing the blower end sidewall 49, FIG. 28B and FIG. 41B, while FIG. 40B shows the sidewall 49 installed. The blower end side wall 49 is slipped over the 2 lobe rotors and also over the 4 lobe rotors 11, in order to lay it in place as shown in FIG. 40B. FIG. 41B is the bottom view of the blower end sidewall 49, FIG. 28B and FIG. 41A. Both FIGS. 41A and 41B are cuts taken just below the outside surface of the blower end sidewall 49, FIG. 28B. FIG. 42 is an outside left side view of the assembled compressor or expander with the gear end on the right.

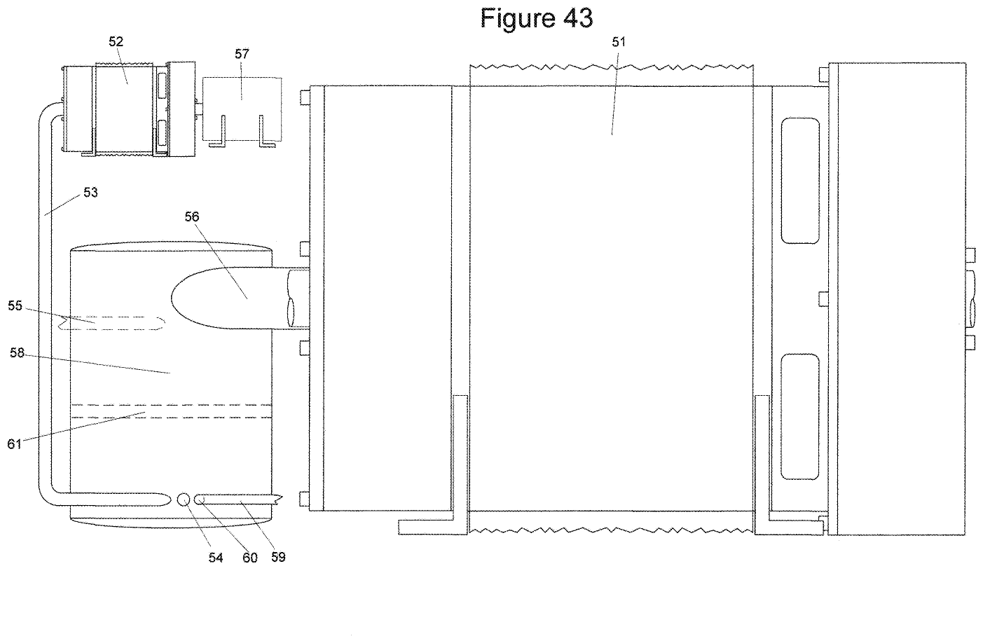

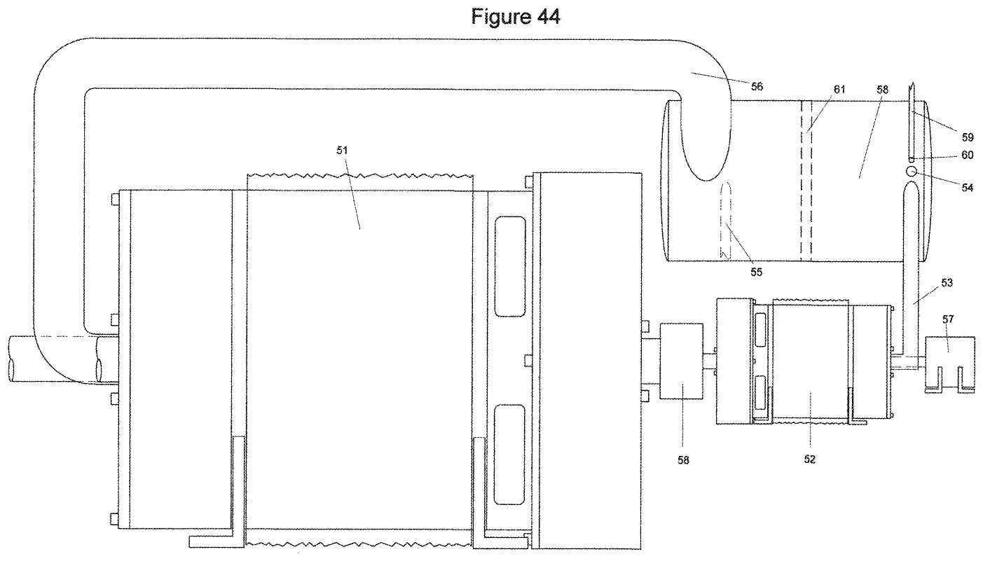

FIG. 43 shows the diagram for an engine which is composed of three main parts, the compressor 52, FIG. 43, the combustion chamber 58, and an expander 51, FIG. 43. In this diagram the compressor 52 is driven by a motor 57, and its compressed air is driven through the high-pressure air pipe 53, FIG. 43, into the combustion chamber 58, FIG. 43. Not shown is a generator attached to the expander which could supply energy for the motor 57 FIG. 43.

Fuel from the high-pressure fuel line 59, FIG. 43, is forced through the fuel nozzle 60 which sprays fuel into the air stream coming through the high-pressure air pipe 53, then this air-fuel mixture is ignited by the igniter 54. The resulting highly expanded gas is allowed to burn as completely as possible before passing through the catalytic converter 61, this gas then enters the high-pressure gas pipe 56 of the expander 51, FIG. 43, then enters the expander, where it rotates the expander rotors, thereby transmitting output torque to shafts of the rotors.

A major change for a catalytic converter 61 is shown in FIG. 43. Instead of installing a catalytic converter in the exhaust system of a conventional engine; were any remaining fuel in the exhaust system is burned, but not harnessed to produce torque. This type of rotary engine allows a similar catalytic converter to be placed within the combustion chamber after as much as possible of the fuel is burned. This burned gas then passes through the catalytic converter, which is placed down stream of this burned gas in the combustion chamber, which then burns any remaining unburned fuel. Therefore, placing the catalytic converter in the combustion chamber allows all of the fuel to be burned in the combustion chamber itself, in order to obtain maximum benefit from the fuel.

In case the temperature of the expander becomes excessive (not enough cooling air can be driven by the fans through cooling channels), a sufficient amount of high-pressure water can be sprayed through the pipe 55 FIG. 43 into the combustion chamber after the fuel is fully burned and just before it enters the high-pressure gas pipe of the expander 58, thereby creating a partial internal combustion steam engine. Steam being created in this manner increases the gas volume in the combustion chamber and more importantly, lowers the operating temperature of the expander. A small amount of combustion chamber heat is lost however, when the high pressure water is converted to steam.

Another solution to the problem expressed in the above paragraph is to increase the size of the compressor so that it produces excess air. All of the compressed air of this oversized compressor can be sent through an after cooler, and the excess of compressed air can be delivered through the pipe 55 FIG. 43 into the combustion chamber, where this cooler compressed air can reduce the combustion temperature enough to prevent damage to the expander 51 FIG. 43.

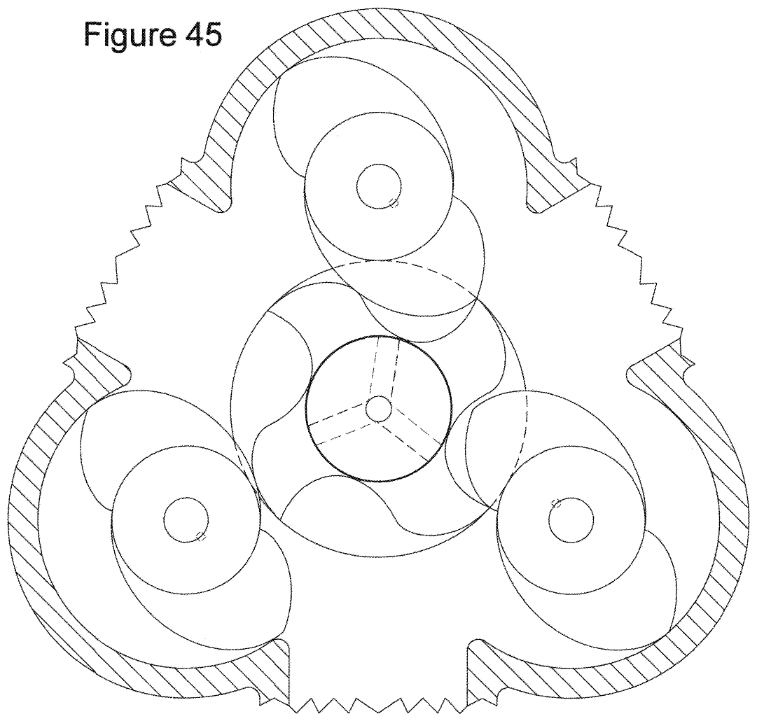

FIG. 44 shows another version of FIG. 43. FIG. 44 still has the same three main parts as shown in FIG. 43, but they are connected differently. The motor 57, FIG. 44 drives the compressor 52, FIG. 44 in the same manner as FIG. 43, and the high pressure discharge pipe of the compressor in FIG. 44 also feeds the combustion chamber 58 in FIG. 44 in the same way as FIG. 43.

The difference between FIG. 43 and FIG. 44 is that in FIG. 44, one of the shafts of the compressor 52, FIG. 44, is mechanically connected to one of the shafts of the expander 51, FIG. 44, by means of an overrunning clutch 58, FIG. 44. This overrunning clutch 58, allows the expander 51 to drive the compressor 52, such as under normal operating conditions, but does not allow the compressor 52 to drive the expander 51 (overrunning), such as when the motor 57, FIG. 44 is driving only the compressor 52, FIG. 44 during starting.

Energy created by the expander 51, FIGS. 43 and 44, is harnessed by attaching a mechanical load to one of the output shafts of the expander 51, FIGS. 43 and 44.

Four Rotor Compressor or Expander and Five Rotor Compressor or Expander

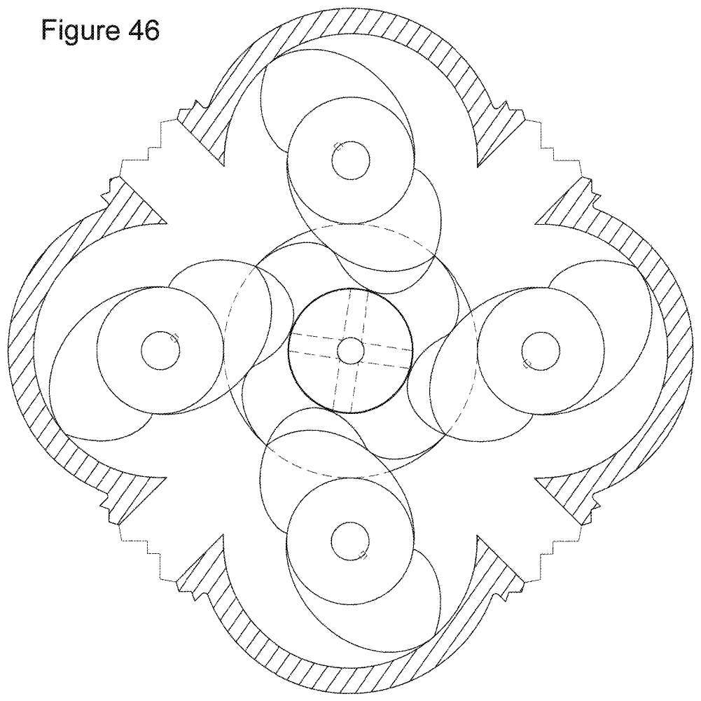

FIG. 45 and FIG. 46

FIGS. 45 and 46 have the same four female lobe rotor in the center of the machine as described previously. FIG. 45 has three male two lobe rotors surrounding the center female four lobe rotor. In other words, the female four lobe rotor has three male two lobe rotors as satellites surrounding the four lobe female sun rotor. FIG. 46 has the same female four lobe sun rotor at the center, but it has four male two lobe rotors acting as satellites surrounding it.

The performance of the machines in FIGS. 45 and 46 is identical to the performance of the two rotor and the three rotor external lobe rotary compressors of expanders, as described previously, with the exception that the capacity of the machines in FIGS. 45 and 46 arc increased because of the additional two lobe (satellite) rotors. These FIGS. 45 and 46 have the same gear ratio namely, two to one. These FIGS. 45 and 46 also have as many intakes (one for each satellite rotor) as satellites. In other words, the four rotor machine has three intakes and the five rotor machine has four intakes.

In FIG. 45, the stationary shaft has three channels connected to the high pressure port at the center, while in FIG. 46 the stationary shaft has four channels connected to the high pressure port.

In a conventional screw compressor, two mating rotors, one male and one female, which resemble screws are assembled in parallel with each other and installed within a housing. These rotors are very costly to manufacture, and it is very difficult to extract all of the gas that has been compressed between the lobes of the rotor screws.

1: Straight lobes cost less.
In a conventional screw compressor, two mating rotors, one male and one female, which resemble screws are assembled in parallel with each other and installed within a housing. These rotors are very costly to manufacture, and it is very difficult to extract all of the gas that has been compressed between the lobes of the rotor. My invention uses straight lobes wherein gas is drawn into a compressor for the full width of the axial lobe and delivered into a full width axial cavity 8, where it is compressed further and finally delivered into the full width channel 7, then into the axial high-pressure port 6.
This invention eliminates the twist of the lobes around the rotor of a conventional screw compressor. In this invention, the lobes are manufactured in line with the axis of the rotor (axially), therefore, the cost of manufacturing the rotors are reduced dramatically, and the natural tendency for the gas to be driven towards the center of the female rotor is taken advantage of, making it much easier to extract all of the gas. The above-mentioned screw compressor is a machine wherein a pocket of gas is drawn between the lobes at the intake port at one end of the screw rotor, then transported axially to the discharge port at the other end of the screw rotor.

2: All of the gas is extracted.
This invention uses straight lobes wherein gas is drawn into a compressor for the full width of the axial lobe and delivered into a full width axial cavity eight, where it is compressed further and finally delivered through the channel 7 into the full width axial high-pressure port six. This invention eliminates the twist of the lobes around the rotor of a conventional screw compressor. In this invention, the lobes are manufactured in line with the axis of the rotor (axially), therefore, the cost of manufacturing the rotors are reduced dramatically, and the natural tendency for the gas to be driven towards the center of the female rotor is taken advantage of, making it much easier to extract all of the gas. The above-mentioned straight lobe compressor is a radial compressor wherein a pocket of gas is drawn between the lobes at the intake port and transported radially inward to the axial discharge port in the center of the female rotor.

3: Elliptical arc leading edge.
The creation of a leading edge of the two lobe rotor which mates with the trailing edge of the for lobe rotor of the radial compressor above is discussed. This novelty is created by using an elliptical arc for leading-edge of the two lobe rotor is shown in FIG. 4, 7 and FIG. 8. FIG. 4 demonstrates how the elliptical arc is created. Its major axis is the horizontal dashed line. The minor axis starts at the center c, FIG. 4, of the horizontal dashed line and extends downward until the ellipse meets the inside end of the trailing edge g, FIG. 4, at the junction f, FIG. 4 thereby creating the elliptical arc extending from f to b, FIG. 4; or J to I, FIG. 9.

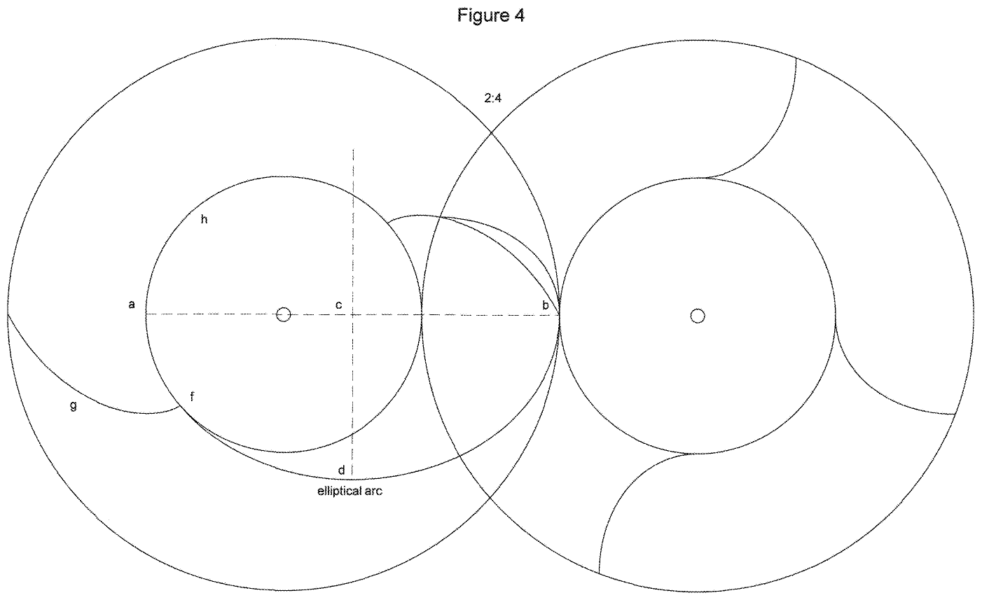

4: Elliptical arc trailing edge.
FIGS. 4 through 9 show how to create the trailing edge of the 4 lobe rotor of a radial compressor or expander. In FIGS. 6 and 7, the elliptical arc of FIG. 4 is spun around the center of the desired 4 lobe rotor. The desired 4 lobe rotor is held stationary while the elliptical arc, which is a part of the 2 lobe rotor, is spun around the stationary 4 lobe rotor. The leading edge k, FIG. 5, is the elliptical arc shown in FIG. 4. This elliptical arc, which uses the center of the 2 lobe rotor as its center, is spun around the four lobe rotor, completing two revolutions while revolving once around the four lobe rotor. This elliptical arc is drawn for every 1° of rotation as shown in FIGS. 6 and 7. The profile thus created is copied from FIG. 6 or FIG. 7, and transferred to FIG. 4 and FIG. 8 in order to create the completed four lobe profiles shown in FIG. 8.

5: The 4 lobe flanged rotor
The creation of a 4 lobe flanged rotor, FIG. 34A, FIG. 34B and FIG. 33C preferably manufactured as a single unit with the flanges designed to be recessed into the stationary sidewalls of the rotor housing so that the inside of the rotor sidewall flanges are flush with the inner surface of the stationary sidewalls 47 and 49 FIG. 28B. This four lobe rotor has air cooling channels, 28 created axially within each of the lobes, FIG. 28aA. Each of these air cooling channels are extended beyond the lobes to the outside surface of the flanges. These channels allow cooling air to be blown through them to prevent overheating of the rotor.

6: The 2 lobe rotor
The creation of a 2 lobe rotor, with air cooling channels, 27, FIG. 28A, created axially through this rotor, allowing cooling air to be blown through them in order to prevent overheating of the rotor.

7: Easy ratio changes
The creation of an easy method for the designer of this compressor or expander to change the compression ratio by rotating the line 13, FIG. 17, clockwise or counterclockwise from the high-pressure port 6 center.

8: Large stationary shaft with high pressure gas channels.
The creation of the large stationary shaft 5, FIG. 25, which is installed inside the rotating four lobe rotor. This large stationary shaft has two high-pressure gas channels 7, FIG. 25, created within it to conduct gas from the high pressure cavity 8 through the slot 9, and into this channel 7, then into the high-pressure port 6, FIG. 25.

9: Large stationary shaft with cooling air channels.
This large stationary shaft 5. FIG. 25, also has two axial cooling air channels created within it to allow cooling air to be blown through it in order to prevent overheating of the large stationary shaft 5 FIG. 25.

10: Cooling air channel for keeping the 4 lobe bearing 22, FIG. 28B cool.
The creation of a cooling air discharge channel 62 between the high pressure gas port 14, FIG. 28B and the blower end four lobe bearing support 15, FIG. 28B. This channel prevents any metal to metal contact between the hot high pressure gas port and the four lobe bearing support, thereby eliminating any metal to metal heat transfer.

11: Gas cavity 8
The creation of a compressed gas cavity 8, FIG. 24, between the lobes. This gas is then pushed through the slots 9 FIG. 24 which were created in the four lobe rotor, FIG. 24. Then this gas is pushed into the high-pressure channel 7, FIG. 24 created in the stationary shaft FIG. 24, and from there into the high-pressure port 6, FIG. 24.

12: Easy slot 9 designing
The creation of an easy method for the designer of this compressor or expander to reduce not only the area of the slots 9, FIG. 20 but also the total axial length of the slots, FIG. 33 a in order to minimize further the small volume of compressed gas that is lost to the intake.

13: Blower pressured plenum
The creation of an air cooling plenum 26, FIG. 28B which is pressurized by a blower used to supply cooling air.

14: From 2 rotors to 5 rotors
There can be from one to four 2 lobe male satellite rotors, surrounding a single female sun rotor (see FIGS. 45 and 46 also FIGS. 9 and 21).

15: Creating an engine with an external lobe rotary compressor and expander
A compressor, expander, fuel pump and a combustion chamber can be combined with basic accessories as shown in FIG. 43 and FIG. 44, to create a basic engine.

16: Cooling expanders with water injection
Pressurized water can be injected into the combustion chamber after the fuel has been burned, in order to create steam. This lowers the temperature and increases the volume of the hot gas going into the expander, creating a steam engine.

17: Cooling expanders with antifreeze mix
Cooling expanders with combustible water-antifreeze mix which can be used during freezing weather (in place of water as described in claim 14).

18: Better use of a catalytic converter
After the volatile fuel has been burned, a catalytic converter 61, FIG. 43 and FIG. 44, can be added in the combustion chamber to completely burn all the remaining unburned fuel. The extra heat created by burning this remaining fuel contributes to the pressure being delivered to the expander; instead of being wasted, which normally occurs when the catalytic converter is installed in the exhaust stream of a reciprocating engine.

19: Use of the overrunning clutch FIG. 44
In FIG. 44, an overrunning clutch 58, is mechanically connected to shaft of the expander. This overrunning clutch 58, allows the expander 51, to drive the compressor, 52, which occurs under normal operating conditions, but does not allow the compressor, 52, to drive the expander 51, (overrunning) such as when the motor 57, is driving only the compressor 52, during starting.

20: Cross-flow cooling
A new method for cooling rotary compressors, rotary expanders, or rotary engines is presented. This new method, which this inventor calls cross-flow cooling, is the idea of blowing cooling air (or other gas) through a cooling air (or other gas) channel created within the rotating or stationary part of a device such as a rotary compressor, expander, or engine which could become overheated.
